(19) United States
(12) Patent Application Publication
(10) Pub. No.: US 2002/0049975 A1
(43) Pub. Date: Apr. 25, 2002

(54) Interactive wagering system with multiple display support

(76) Inventors: William L. Thomas, Bixby, OK (US); Masood Garahi, Superior, CO (US)

Correspondence Address: FISH & NEAVE, 1251 AVENUE OF THE AMERICAS, 50TH FLOOR, NEW YORK, NY, 10020-1105, US

(21) Appl. No.: 09/824,940

(22) Filed: Apr. 3, 2001

Related U.S. Application Data
(60) Provisional application No. 60/194,909, filed on Apr. 5, 2000.

(51) Int. Cl. H04N 5/445; G06F 13/00

(52) U.S. Cl. 725/60; 725/1

(57) ABSTRACT

An interactive wagering system is provided that supports multiple user displays. A user may watch video using a first display while synchronized content such as interactive wagering opportunities are provided on a second display. The first display may be a television connected to a set-top box or other suitable equipment. The second display may be part of a personal computer, a cellular telephone with a display, a handheld computer, or other suitable device. The first and second displays may be synchronized using direct or indirect links. A server at a cable system headend or other location may be used to display content on the second display that is synchronized with the content displayed on the first display.

This application claims the benefit of U.S. provisional application No. 60/194,909, filed Apr. 5, 2000 which is hereby incorporated by reference herein in its entirety.

### BACKGROUND OF THE INVENTION

This invention relates to interactive wagering, and more particularly, to interactive wagering applications that support multiple displays.

Wagering is a popular leisure activity. For example, many racing fans wager on events such as horse, dog, and harness racing. However, it may be inconvenient to attend racing events in person. Not all racing fans have sufficient time to visit racetracks as often as they would like and some fans have difficulties in obtaining suitable transportation to the track. Off-track betting establishments are available for fans who cannot attend racing events in person, but fans must still travel to the off-track betting establishments.

As a result, systems have been developed in which fans may place off-track wagers using personal computers connected to the Internet, standard telephones, or set-top boxes.

It is an object of the present invention to improve such systems by providing an interactive wagering system that supports multiple simultaneous displays.

### SUMMARY OF THE INVENTION

An interactive wagering system is provided in which wagering-related content and interactive wagering opportunities may be provided to a user using multiple displays. For example, a wagering-related television channel may be provided to the user on a first display such as a television display and a wagering interface may be provided to the user on a second display such as a computer display, the display of a handheld computer, another television display, a remote control display, or any other suitable display device.

If desired, the content and options that are displayed on the displays may be synchronized. For example, if a particular racetrack is being promoted on a wagering-related television channel being displayed on the first display, an interactive wagering application may provide the user with a wagering opportunity by displaying on-screen options on the second display (e.g., the user's computer or other secondary display device).

The interactive wagering application may be implemented on user equipment such as a set-top box (e.g., the same set-top box that is handling the content on the first display), a personal computer, a handheld computer, a server (e.g., a server at a cable system headend), or using any other suitable platform. In some arrangements the interactive wagering application functions may be implemented using a client-server arrangement or distributed computing architecture in which some functions are handled using one platform and other functions are handled using another platform.

The interactive wagering application may be used to place wagers on various different types of races, including dog races, horse races, harness races, etc.

Further features of the invention, its nature and various advantages will be more apparent from the accompanying drawings and the following detailed description of the preferred embodiments.

### BRIEF DESCRIPTION OF THE DRAWINGS

FIG. 1 is a schematic diagram of an illustrative interactive wagering system on which an interactive wagering application may be implemented in accordance with the present invention.

FIG. 2 shows an illustrative main menu region that may be displayed on top of a video in accordance with the present invention.

FIG. 3 shows an illustrative racetrack selection screen that may be provided by the interactive wagering application in accordance with the present invention.

FIG. 4 shows an illustrative race selection screen that may be provided by the interactive wagering application in accordance with the present invention.

FIG. 5 shows an illustrative wager type selection screen that may be provided by the interactive wagering application in accordance with the present invention.

FIG. 6 shows an illustrative horse selection screen that may be provided by the interactive wagering application in accordance with the present invention.

FIG. 7 shows an illustrative wager amount selection screen that may be provided by the interactive wagering application in accordance with the present invention.

FIG. 8 shows an illustrative wager list screen that may be provided by the interactive wagering application in accordance with the present invention.

FIG. 9 shows an illustrative track selection screen that may be provided to a user in accordance with the present invention.

FIG. 10 shows an illustrative race selection screen that may be provided to the user in accordance with the present invention.

FIG. 11 shows an illustrative wager type selection screen that may be provided to the user in accordance with the present invention.

FIG. 12 shows an illustrative horse selection screen that may be provided to the user in accordance with the present invention.

FIG. 13. shows an illustrative wager amount selection screen that may be provided to the user in accordance with the present invention.

FIG. 14 shows an illustrative wager list screen that may be provided to the user in accordance with the present invention.

FIG. 15 is a flow chart of illustrative steps involved providing a user with an interactive wagering opportunity in accordance with the present invention.

FIG. 16 shows a setup options screen that may be provided in accordance with the present invention.

FIG. 17 shows an illustrative display options screen that may be provided to the user in accordance with the present invention.

FIG. 18 is a schematic diagram showing how a set-top box may be used to support a television display and a personal computer display in accordance with the present invention.

FIG. 19 is a front view of a cellular telephone with a display that may be used to provide users with interactive wagering opportunities in accordance with the present invention.

FIG. 20 is a front view of a remote control with a display that may be used to provide users with interactive wagering opportunities in accordance with the present invention.

FIG. 21 is a schematic diagram of an interactive wagering arrangement based on user equipment having two displays in accordance with the present invention.

FIG. 22 is a schematic diagram of an interactive wagering arrangement based on two user equipment devices each having a separate display in accordance with the present invention.

FIG. 23 is a schematic diagram of an illustrative interactive wagering arrangement in which a single set-top box supports a television with a display and a personal computer with a display.

FIG. 24 is a schematic diagram of an illustrative and arrangement in which a single set-top box supports two television displays for a user in accordance with the present invention.

FIG. 25 is a schematic diagram showing how a television with a processor and a personal computer may serve as two displays for the user in accordance with the present invention.

FIG. 26 is a schematic diagram of an arrangement in which one of two display devices for a user is communicating over a wireless link in accordance with the present invention.

FIG. 27 is a schematic diagram showing how multiple display devices for a single user may be supported through a network connection in accordance with the present invention.

FIG. 28 is a schematic diagram showing how a user may be simultaneously provided with content on a television and interactive wagering opportunities on a wireless device such as a cellular telephone with a display in accordance with the present invention.

FIG. 29 is a flow chart of illustrative steps involved in supporting multiple displays in an interactive wagering environment in accordance with the present invention.

FIG. 30 is a schematic diagram showing how video content on one display may be synchronized with the interactive wagering content provided on another display in accordance with the present invention.

FIG. 31 is a schematic diagram showing how a region of web-based interactive wagering content may be displayed at the same time as television content in accordance with the present invention.

FIG. 32 is a flow chart of illustrative steps involved in displaying video and web-content in accordance with the present invention.

### DETAILED DESCRIPTION OF THE PREFERRED EMBODIMENTS

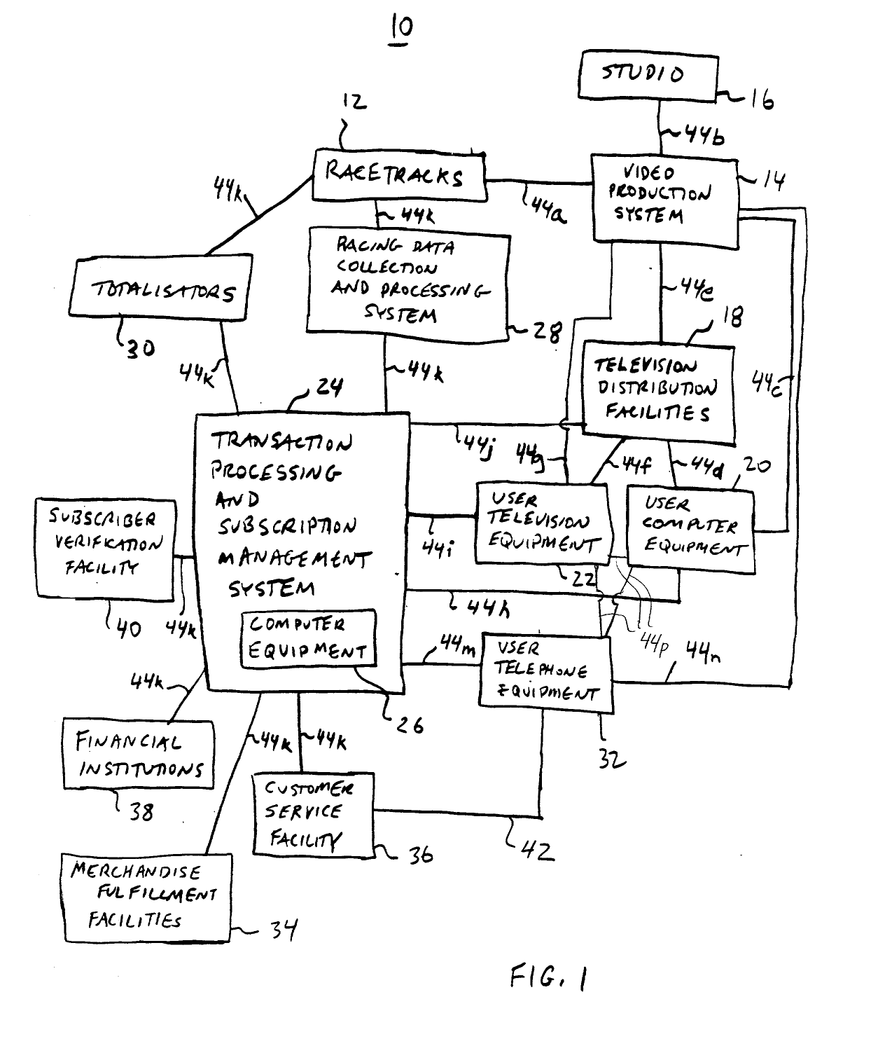

An illustrative interactive wagering system 10 in accordance with the present invention is shown in FIG. 1. Aspects of the invention apply to various different types of wagering, but are described herein primarily in the context of interactive wagering on races (e.g., horse races) for specificity and clarity.

Races may be run at racetracks 12, which may be located at various geographic locations. Races run at the racetracks may be simulcast to television viewers. For example, simulcast videos may be provided to users with satellite receivers or to off-track betting establishments via satellite.

System 10 may be used to provide an interactive wagering service to users of various user equipment. An interactive wagering application may be used to provide the wagering service. The interactive wagering application may run locally on the user equipment (e.g., on a set-top box, personal computer, cellular telephone, handheld computing device, etc.) or may run using a client-server or distributed architecture where some of the application is implemented locally on the user equipment in the form of a client process and some of the application is implemented at a remote location (e.g., on a server computer or other such equipment in the system) as a server process. These arrangements are merely illustrative. Other suitable techniques for implementing the interactive wagering application may be used if desired.

Real-time videos from racetracks 12 may also be provided to video production system 14 for distribution to users as part of a television wagering service (i.e., a wagering-related television channel or Internet-delivered service or the like). If desired, multiple simulcast videos may be provided to video production system 14 in real-time. Talent (e.g., commentators) for the television wagering service provided by the interactive wagering application may be located at studio 16. Studio 16 may provide a video feed containing commentary and the like to video production system 14. Graphic overlays for the television wagering service may be added to the service at video production system 14.

The television wagering service may use video production system 14 to combine selected video segments from desired racing simulcasts with the video feed from studio 16 and suitable graphic overlays. If desired, video production system 14 or a separate facility may be used to reformat simulcasts from racetracks 12. For example, if racetracks 12 provide simulcasts as traditional analog television channels, video production system 14 (or a separate facility) may convert these simulcasts or portions of these simulcasts into digital signals (e.g., digital video signals) or into a different number of analog signals. Digital video signals may require less bandwidth than analog video signals and may be appropriate for situations in which videos are to be transmitted over either high or low bandwidth pathways. Low bandwidth pathways may include telephone lines, the Internet, etc.

Video production system 14 may be used to provide a television wagering service that includes selected simulcast videos, video from studio 16, and graphic overlays to television distribution facilities 18 (for redistribution to user television equipment 22 and user computer equipment 20), to user computer equipment 20, and to user telephone equipment 32 (if user telephone equipment 32 has a display capable of displaying moving images). Television distribution facilities 18 may be any suitable facilities for supplying television to users, such as cable system headends, satellite systems, broadcast television systems, or other suitable systems or combinations of such systems. User computer equipment 20 may be any suitable computer equipment that supports an interactive wagering application. For example, user computer equipment 20 may be a personal computer. User computer equipment 20 may also be based on a mainframe computer, a workstation, a networked computer or computers, a laptop computer, a notebook computer, a handheld computing device such as a personal digital assistant or other small portable computer, etc.

Each of television distribution facilities 18 is typically located at a different geographic location. Users with user television equipment 22 may receive the television wagering service from an associated television distribution facility. User television equipment 22 may include, for example, a television or other suitable monitor. A television may be used to watch the television wagering service on a traditional analog television channel. User television equipment 22 may also include a digital or analog set-top box connected to a television distribution facility 18 by a cable path. A digital set-top box may be used to receive the television wagering service on a digital channel. If desired, user television equipment 22 may contain a satellite receiver, a WebTV box, a personal computer television (PC/TV), or hardware similar to such devices into which set-top box capabilities have been integrated. For example, user television equipment 22 may be based on a television that includes embedded processing capabilities of the type provided by set-top boxes. A recording device such as a videocassette recorder or digital recording device (e.g., a personal video recorder or digital video recorder based on hard disk drives or the like) may be used in user television equipment 22 to store videos. The recording device may be separate from or part of the other components of user television equipment 22.

User computer equipment 20 may receive the television wagering service using a video card or other video-capable equipment to receive analog or digital (e.g., moving picture experts group or MPEG) videos from a television distribution facility. User computer equipment 20 may also receive the television wagering service directly from video production system 14 using, for example, a modem link. If desired, the video for the television wagering service may be compressed (e.g., using MPEG techniques). This may be useful, for example, if the path to user computer equipment 20 is a modem connection using telephone links. If video production system 14 is only used to serve user computer equipment 20 without traditional analog television capabilities, video production system 14 may only need to supply such digitally-compressed video signals and not analog television signals.

Video clips of races and other simulcast information may be provided to users in the form of a television wagering service or by an interactive wagering service provided by the interactive wagering application. If desired, race-related videos may be provided to the user by using video production system 14 or other suitable equipment to route appropriate video clips from the simulcasts to the user in real time. Video clips may also be stored for later viewing. For example, one or more video servers located at racetracks 12, video production system 14, television distribution facilities 18, or other suitable locations may be used to store video clips. The stored videos may then be played back in real time or downloaded for viewing at user television equipment 22, user computer equipment 20, or user telephone equipment 32. The video clips may contain videos of races, commentary, interviews with jockeys, or any other suitable race-related information. If desired, real-time or stored videos may be provided from racetracks 12 directly to user television equipment 22, user computer equipment 20, or user telephone equipment 32 over the Internet or other suitable communications paths without involving video production system 14. Videos may also be provided by routing video signals through equipment located elsewhere in system 10. For example, videos may be routed through transaction processing and subscription management system 24.

Transaction processing and subscription management system 24 may contain computer equipment 26 and other equipment for supporting system functions such as transaction processing (e.g., handling tasks related to wagers, product purchasing, adjusting the amount of funds in user accounts based on the outcomes of wagers, video clip ordering, etc.), data distribution (e.g., for distributing racing data to the users), and subscriber management (e.g., features related to opening an account for a user, closing an account, allowing a user to add or withdraw funds from an account, changing the user's address or personal identification number, etc.). Databases within transaction processing and subscription management system 24 or associated with system 24 may be used to store racing data, wagering data and other transaction data, and subscriber data such as such as information on the user's current account balance, past wagering history, individual wager limits, personal identification number, billing addresses, credit card numbers, bank account numbers, social security numbers, etc. Using such databases may allow the user to access information more quickly and allows for central administration of the wagering service.

If desired, racing videos and other services may be provided using servers and other equipment located at transaction processing and subscription management system 24. For example, video clips may be provided to the user on-demand. Interactive advertisements may be provided to the user. When the user selects a desired advertisement, transaction processing and subscription management system 24 may provide additional information or other services related to the advertisement to the user.

Product ordering services may be implemented using computer equipment at transaction processing and subscriber management system 24 to handle orders and to assist in adjusting the appropriate account of the user accordingly. Orders may be fulfilled using merchandise fulfillment facilities 34. Merchandise fulfillment facilities 34 may be operated solely to provide merchandise fulfillment or may be associated with independently-operated mail-order or on-line businesses. Similar facilities may be used to allow users to order services.

Statistical racing data such as the post times for each race, jockey names, runner names and the number of races associated with each track, handicapping information (e.g., information on past performances such as the number of wins and losses for the past year, etc.), and weather conditions at various tracks may be provided by racing data collection and processing system 28. Some of the data may be collected from racetracks 12 and some may be provided by third party information sources such as Axcis Pocket Information Network, Inc. of Santa Clara, Calif. or other suitable data sources.

Racing data may also be provided from totalisators 30. Totalisators 30 are the computer systems that may be used to handle wagers made at the racetracks, made at off-track betting establishments, and made using interactive wagering system 10. Totalisators 30 generate wagering odds in real time. Totalisators 30 generate these odds based on information on which wagers are being placed (e.g., based on information on which wagers are being placed on races at racetracks 12). Totalisators 30 are available from companies such as Amtote International, Inc. of Hunt Valley, Md. Totalisators 30 may be associated with individual racetracks 12 or groups of racetracks 12. Totalisators 30 may communicate with one another using a communication protocol known as the Intertote Track System Protocol (ITSP). This allows totalisators 30 to share wagering pools. Totalisators 30 may provide racing data including information on the current races at racetracks 12, the number of races associated with each racetrack, win, place, and show odds and pool totals for each horse or other runner, and exacta, trifecta, and quinella payoff predictions and pool totals for every possible combination of runners. Totalisators 30 may also provide current odds and other real-time racing data for other types of wagers. Totalisators 30 may provide the time until post time for each race.

Totalisators 30 may provide race results, such as the order-of-finish list for at least the first three positions and payoff values versus a standard wager amount for win, place, and show, for each runner in the finish list. Payoff values may be provided for winning complex wager types such as exacta, trifecta, quinella, pick-n (where n is the number of races involved in the pick-n wager), and daily double. The payoff values may be accompanied by a synopsis of the associated finish list.

Totalisators 30 may also provide program information of the type typically provided in printed racing programs. Such program information may include early odds, early scratches, race descriptions (including the distance of each race and the race surface—grass, dirt, artificial turf, etc.), allowed class ratings (based on a fixed ratio of external criteria), purse value (payoff to winning runner), allowed age range of runners, and the allowed number of wins and starts for each runner.

If desired, some of the information provided to transaction processing and subscription management system 24 by totalisators 30 (such as the program information or other suitable racing data) may be provided by racing data collection and processing system 28. Similarly, some of the information provided to transaction processing and subscription management system 24 by racing data collection and processing system 28 may be provided by totalisators 30. Moreover, the foregoing examples of different suitable types of racing data are merely illustrative. Any suitable data related to racing may be provided to transaction processing and subscription management system if desired.

Transaction processing and subscription management system 24 provides the racing data to users at user television equipment 22, user computer equipment 20, and user telephone equipment 32 for use in following race results and developing wagers. If desired, racing data may be provided to users using paths that do not directly involve transaction processing and subscription management system 24. For example, racing data may be provided from racing data collection and processing system 28 to user television equipment 22, user computer equipment 20, or user telephone equipment 32 using the Internet or other suitable communications paths.

User telephone equipment 32 may be a conventional telephone, a cordless telephone, a cellular telephone or other portable wireless telephone, or any other suitable telephone equipment. Users at user television equipment 22 and user computer equipment 20 may view information on the racing data on a television or other suitable monitor. Users at user telephone equipment 32 may listen to racing data using an interactive voice system. User telephone equipment 32 may be based on cellular telephones with displays. Users may view racing data displayed on such displays.

Users who wish to place wagers may establish an account at transaction processing and subscription management system 24. An account may also be established at one of totalisators 30. The user and the interactive wagering services may have their own bank accounts at financial institutions 38. A user may set up an account electronically by using user television equipment 22, user computer equipment 20, or user telephone equipment 32 to interact with the subscriber management functions of transaction processing and subscription management system 24. If desired, accounts may be established with the interactive wagering service with the assistance of customer service representatives at customer service facility 36. Customer service facility 36 may be at the same location as transaction processing and subscription management system 24, may be part of system 24, or may be located remote from system 24. Customer service representatives at customer service facility 36 may be reached by telephone. If user telephone equipment 32 is used to access the interactive wagering service, for example, user telephone equipment 32 may be used to reach the customer service representative using communications path 42. If user television equipment 22 or user computer equipment 20 is being used with the service, a telephone at the same location as that equipment may be used to reach the customer service representative.

The user's identity may be checked using social security number information or other identification information with the assistance of subscriber verification facility 40. The services of subscriber verification facility 40 are used to ensure that the user lives in a geographic area in which wagering is legal, that the user is of a legal age, and that the identification information (e.g., the user's social security number) matches the name provided by the user. If the user is using a cellular telephone or handheld computing device, the user's present physical location may be determined by determining which general part of the cellular telephone network is being accessed by the user or by using the cellular network or a handset-based location device such as a global positioning system (GPS) receiver in the body of the cellular telephone to pinpoint the user's location. This location information may be used to verify that the user is located in a geographic area where wagering is legal.

In a typical enrollment process, the user provides personal information to the interactive wagering service and provides funds with a credit card or funds from the user's bank account. The interactive wagering service sets up an account for the user at transaction processing and subscription management system 24 and directs one of totalisators 30 to set up a new account for the user at the totalisator. The totalisator is also directed to credit the user's account to reflect the amount of funds provided by the user. After the user places a wager and wins or loses, the totalisator adjusts the user's totalisator account to reflect the outcome of the wager. The totalisator may periodically inform the interactive wagering service of the adjusted balance in the user's account. This may be accomplished using any suitable technique (e.g., periodically, continuously, on-request, etc.). For example, reports may be collected periodically (e.g., once a day in an end-of-day report) and provided to the interactive wagering service to reconcile the account balances at transaction processing and subscription management system 24 with the account balances at totalisators 30.

If the user makes a balance inquiry, the inquiry may be passed to the appropriate totalisator by transaction processing and subscription management system 24. If the user is charged a fee for subscribing to the service, the service may debit the fee from the user's account at the transaction processing and subscription management system 24.

The accounts at totalisators 30 and transaction processing and subscription management system 24 are typically maintained separately, because the business entities that operate totalisators 30 and transaction processing and subscription management system 24 are independent. If desired, financial functions related to opening and maintaining user accounts and the like may be handled using computer equipment at another location such as one of financial institutions 38 or other location remote from totalisators 30 and system 24. Such financial functions may also be implemented primarily at a totalisator 30 or primarily at the transaction processing and subscription management system 24 if desired.

Users at user television equipment 22, user computer equipment 20, and user telephone equipment 32 may place wagers by providing wagering data and otherwise interacting with transaction processing and subscription management system 24. The interactive wagering service may provide a user at user television equipment 22, user computer equipment 20, or user telephone equipment 32 that has display capabilities with screens containing various racing data. For example, the user may be presented with screens that allow the user to view the current odds for horses in an upcoming race at a given track.

The service may provide the user with interactive screens containing menus and selectable options that allow the user to specify the type of wager in which the user is interested and the desired wager amount. With a set-top box arrangement, for example, the user may use a remote control or wireless keyboard to navigate the various menus and selectable options. With a personal computer, the user may use a keyboard, mouse, trackball, touch pad, or other suitable input or pointing device. With a cellular telephone with a display, the user may use buttons on the telephone. When the user has made appropriate selections to define a desired wager, the user television equipment, user computer equipment, or user telephone equipment may transmit wagering data for the wager to transaction processing and subscription management system 24.

Users with telephones may also interact with the service using an interactive voice response system located at transaction processing and subscription management system 24. The interactive voice response system may present menu options to the user in the form of audio prompts (e.g., “press 1 to select a $2 wager amount,” etc.). The user may interact with the service be pressing the corresponding buttons on a touch tone telephone. User telephone equipment 32 that is based on cellular telephones allows the user to interact with the wagering service in this way. User telephone equipment 32 that is based on cellular telephones with messaging and display capabilities also allows the user to interact visually with the interactive wagering service.

The components of system 10 may be interconnected using various communications paths 44. Communications paths 44 may include satellite paths, coaxial cable paths, fiber-optic paths, twisted pair paths, other wire or cable-based links, wireless paths through free space, or any other suitable paths or combination of such paths. Communications over paths 44 may involve analog transmissions, digital transmissions, wireless transmissions, microwave transmissions, radio-frequency transmissions, optical transmissions, audio transmissions, or any other suitable type of transmissions or combination of such transmissions. Communications may involve Internet transmissions, private network transmissions, packet-based transmissions, television channel transmissions, transmissions in the vertical blanking interval of a television channel or on a television sideband, MPEG transmissions, etc. Communications may involve wireless pager or other messaging transmissions. Communications paths 44 may include cable connected to cable modems, digital subscriber lines, integrated services digital network (ISDN) lines, or any other suitable paths. Examples of suitable communications paths are described below. Those examples are, however, merely illustrative. Any of the communications path arrangements described above or other suitable arrangements may be used if desired.

Communications paths that carry video and particularly uncompressed analog video or lightly-compressed or full-screen digital video generally use more bandwidth than communications paths that carry only data or that carry partial-screen digital video. For example, if it is desired to transmit high-quality simulcasts of races from racetracks 12 to video production system 14, analog or digital videos may be transmitted from racetracks 12 to video production system 14 over path 44a using satellite links. Video may be transmitted from studio 16 to video production system 14 over path 44b using a satellite link or a high-speed terrestrial path such as a fiber-optic path. Studio 16 may also be located at the same site as video production system 14, thereby avoiding the need for a long-haul transmission path. Videos may be transmitted from video production system 14 to user computer equipment 20 over path 14c using a modem link (using, for example, a digital subscriber line, a telephone network link, a wireless link etc.) The modem link may be made over a private network.

A user with a cable modem may connect a personal computer or other such user computer equipment 20 to an associated cable system headend using path 44d. (The headend in such an arrangement would be one of the television distribution facilities 18 shown in FIG. 1.) The user may then receive videos from the headend via cable modem. Videos may be provided to the headend over path 44e using a network link, fiber optic links, cable links, microwave links, satellite links, etc. A user with a set-top box or similar device (shown in FIG. 1 as user television equipment 22) may also receive videos from a cable system headend using a cable modem or other such communications device over path 44f. In addition, a user with user television equipment may receive videos over the Internet or a private network using a telephone-based modem or other such communications device using path 44g. In a system with distributed processing, interactive wagering services may be provided using a television distribution facility 18 that includes equipment that supplements or replaces at least some of the equipment at transaction processing and subscription management system 24.

If desired, user television equipment 22 or user computer equipment 20 may receive analog or digital videos from an associated television distribution facility over the communications paths normally used to distribute television programming (e.g., paths 44f and 44d). For example, videos may be received as part of a dedicated interactive wagering service television channel. If videos are provided as digital signals (e.g., MPEG signals), 10 or more digital videos may be carried on a single analog channel (or one digital video may be carried on one-tenth of the bandwidth of an analog channel). If the videos are not full-screen videos, even more videos may be simultaneously provided without a loss of image quality.

Racing videos may be provided to user telephone equipment 32 over a partially-wireless telephone Internet link or other telephone link using path 44n.

If desired, racing data may accompany the racing videos along any of these paths. Moreover, racing videos may be provided by routing them directly from racetracks 12 to user television equipment 22, user computer equipment 20 (e.g., over the Internet or a private network, etc.), or user telephone equipment 32. Racing videos may also be provided by routing them through transaction processing and subscription management system 24. If a cellular telephone or portable computing device has sufficient display capabilities to support moving images, racing videos may be displayed. Such videos may be provided using any suitable path, such as a direct path from racetracks 12, a path through video production system 14 or other suitable video processing equipment, through a hub such as transaction processing and subscription management system 24, etc. Racing videos may be provided in real time or may be recorded for later distribution. Videos that are not provided in real-time may be downloaded by user television equipment 22, user computer equipment 20, a cellular telephone, or other suitable user equipment at a lower data rate than would otherwise be required and may be downloaded in the background if desired. Such videos may also be provided to the user at real-time video rates for direct viewing by the user.

Racing data and other information related to the interactive wagering service may be provided to users over paths connected to transaction processing and subscription management system 24. For example, racing data and other data for the service may be provided to user computer equipment 20 over path 44h using a modem link. Path 44h may be a private network path or an Internet path. Path 44h may use telephone lines, digital subscriber lines, ISDN lines, wireless data paths, or any other suitable type of communications links. User television equipment 22 may receive data for the wagering service over communications path 44i, which may be a telephone line, digital subscriber line, ISDN line, or other suitable type of communications path and which may use a private network path or an Internet path, etc.

Data for the wagering service may be provided to users of the interactive wagering application via communications path 44j and paths 44f and 44d. Communications path 44j may be provided over a private network, using the public telephone network, using satellite links, or any other suitable type of links. Data from paths such as path 44j may be routed to paths such as paths 44f and 44d directly by associated television distribution facilities 18, or may be buffered at television distribution facilities 18 if desired. Paths 44f and 44d may include coaxial cable and use of paths 44f and 44d may involve the use of cable modems or the like. If data is provided over path 44j and path 44f or path 44d using an Internet protocol, a web browser or similar software running on user television equipment 22 or user computer equipment 20 may be used to access the data. Such software may be integrated into the interactive wagering application or may be used separately. Software may also be used to view videos and may be used on other platforms (e.g., advanced cellular telephones) if desired.

The communications paths 44k that are used to connect various other components of the system typically do not carry high-bandwidth video signals. Accordingly, paths 44k may be telephone-like paths that are part of the Internet or a private network. Such paths and various other paths 44 may be dedicated connections for security, reliability, and economy.

User telephone equipment 32 may receive information for the wagering service via path 44m. If user telephone equipment 32 is a standard (non-cellular) telephone, such information may be in the form of audio prompts (“press 1 to place a wager”) and audio racing data (“the current win odds for horse 2 are 5-1”). Transaction data processing and subscription management system 24 may contain interactive voice response equipment that provides such information to the user and that responds to touch-tone signals from the user when the user responds to prompts by pressing buttons on the user's telephone.

If user telephone equipment 32 is a cellular telephone, racing data and other information for the interactive wagering service may be provided to the user by using a cellular wireless connection as part of path 44m. Users with cellular telephones may be provided with audio prompts using an interactive voice response system located at transaction processing and subscription management system 24 to which the users may respond by pressing cellular telephone buttons to generate touch-tone signals.

Racing data and other information for the interactive wagering service may be provided to cellular telephones in the form of alphanumeric messages. Such messages may be transmitted to the user by using paging or other alphanumeric messaging formats or any other suitable data communications scheme. If desired, data may be provided to the cellular telephones over the voice channel and decoded by the cellular telephone using modem circuitry or other suitable circuitry. Data may also be provided using any other suitable cellular or wireless path. Regardless of the way in which racing data and other information for the interactive wagering service are provided to the cellular telephone, such information may be provided to the user by displaying it on the cellular telephone display screen or by presenting it in audible form through the speaker of the cellular telephone.

Racing data and other interactive wagering service information for the users may be provided in one or more continuous data streams, may be provided periodically (e.g., once per hour or once per day), or may be provided using a client-server arrangement in which data is requested by a client processor (e.g., user television equipment 22, user computer equipment 20, user telephone equipment 32, or any other such equipment) from a server (e.g., a server implemented using computer equipment 26 at transaction processing and subscription management system 24 or computer equipment at another suitable location). Videos may also be provided using any of these techniques.

A return communications path between the user and the interactive wagering service may be used to allow the user to place wagers and otherwise interact with the interactive wagering service. For example, a user with a standard telephone or a cellular telephone may interact with the service by pressing touch-tone keys on the telephone in response to audio prompts provided by an interactive voice response system at transaction processing and subscription management system 24. If desired, users may call customer service representatives at customer service facility 36 and place wagers with manual assistance. The user of a cellular telephone may interact with the wagering service by selecting menu options and otherwise interacting with information displayed on the cellular telephone. When a selection is made, software implemented on the telephone may be used to assist the user in transmitting appropriate data (e.g., wagering data) to the wagering service. Such data may be transmitted using any suitable technique. For example, data may be transmitted using a wireless data link that is separate from the cellular voice channels. Data may also be transmitted over the voice channel (e.g., using a modem built into the cellular telephone, by automatically generating touch-tone signals that may be recognized by the interactive voice response system at transaction processing and subscription management system 24, or using any other suitable arrangement). These approaches may be used even if the user receives racing data and other information for the service using a platform other than a telephone-based platform.

Users with user television equipment 22 may interact with the service by sending data (e.g., wager data) to transaction processing and subscription management system 24 using path 44i or using paths 44f and 44j. Users with user computer equipment 20 may send data (e.g., wager data) to transaction processing and subscription management system 24 via path 44h or paths 44d and 44j. Users at any user equipment may send data for the service to locations other than transaction processing and subscription management system 24. For example, the user may provide information directly to customer service facility 36, etc.

If desired, the user may send data to the service at transaction processing and subscription management system 24 using different paths than those used to receive data from transaction processing and subscription management system 24. For example, racing data may be received at user television equipment 22 via paths 44j and 44f, whereas data may be sent by the user from user television equipment 22 to transaction processing and subscription management system 24 using path 44i, etc. Moreover, the paths used to receive certain video information may be different from those used to receive racing data. For example, user television equipment 22 may receive racing videos using path 44f, but may receive racing data using path 44i. These examples are merely illustrative. Any suitable combination of paths may be used to distribute racing data and other information for the interactive wagering service, any suitable combination of paths may be used to receive videos, and any suitable combination of paths may be used to send data to the wagering service.

If desired, the user may interact with the wagering service using more than one platform. For example, the user may place a wager using a cellular telephone while the user is driving home. When the user arrives home, the user may determine the outcome of the wager by watching a video of the race on user television equipment. Later in the day, the user may check the user's account balance using a personal computer.

As another example, the user may configure the system so that wagering-related video content may be displayed on one device (e.g., a television display or other user television equipment), whereas interactive wagering opportunities (e.g., on-screen wager-creation options) may be displayed on another device (e.g., a personal computer display or other user computer equipment or a cellular telephone display or other user telephone equipment). The delivery of the content and interactive wagering opportunities to such devices may be coordinated. If desired, paths such as paths 44p may be used in coordinating the delivery of television or other video content and interactive wagering opportunities or other interactive content. For example, a path 44p between a set-top box in a user's television equipment 22 and that user's computer equipment 20 may be used to send signals from the set-top box to the user's computer equipment 20 that cause the user's computer equipment 20 to display certain interactive wagering opportunities to the user (e.g., by retrieving certain web pages). Such signals may be sent, for example, when the set-top box determines that the user has tuned to a wagering-related television channel with the set-top box. This is merely illustrative. Any suitable arrangement may be used to send signals or otherwise coordinate the operation between a first user device and a second user device.

Although system 10 has been described in the context of a system that supports multiple wagering platforms, system 10 may support fewer platforms if desired. For example, aspects of the invention may be implemented using a system 10 that does not support telephone wagering or that does not support personal computer wagering.

The interactive wagering features of the present invention may be implemented using any suitable platform (user television equipment, user telephone equipment, etc.). In set-top box arrangements, on-screen options may be made larger than they appear in computer-based arrangements to accommodate the greater viewing distance from which televisions are typically operated. Options may be selected by highlighting them using remote control arrow keys and by pressing an appropriate key such as an OK or enter or select key. In cellular telephone arrangements and handheld computer arrangements, options and information may be displayed using smaller screens than are typically available on personal computer or set-top box arrangements. To accommodate the smaller screen size, options that might otherwise be presented on a single screen may be displayed using multiple screens or layered menus. Options may be selected by highlighting them using navigation keys and pressing an appropriate select button on the cellular telephone or handheld computing device or by using a pen-based interface or the like.

The interactive wagering application may be implemented using application software that runs primarily on user television equipment, user computer equipment, user telephone equipment, or another local platform, or using a remote server or other computer that is accessed from the local platform. Arrangements in which interactive wagering services are implemented using software on remote computers that is accessed on-demand from local platforms may be referred to as client-server arrangements. Such client-server arrangements may be used to allow client processes on set-top boxes or other platforms to access server processes running on servers located at cable system headends or other television distribution facilities 18 (FIG. 1). Regardless of the type of system architecture or platform used, the software that supports the interactive wagering service features described herein may be referred to as an interactive wagering application.

In a set-top box environment or other environment in which television is being displayed for the user, the system may allow the user to launch the interactive wagering application by pressing a menu option in an interactive television program guide or other interactive television application. If desired, the application may be launched automatically whenever the user tunes to a particular channel (e.g., the television wagering channel). After the user has tuned to this channel, the system may display an interactive icon on the user's television screen that indicates that the interactive wagering application is available. If the user presses an “OK” remote control key, the system may launch the application.

In a computer-based system, the user may access the interactive wagering application by browsing to an Internet web site or a site on a private network.

Systems based on cellular telephones or the like may be launched by selecting an appropriate on-screen menu option presented on the display of the cellular telephone.

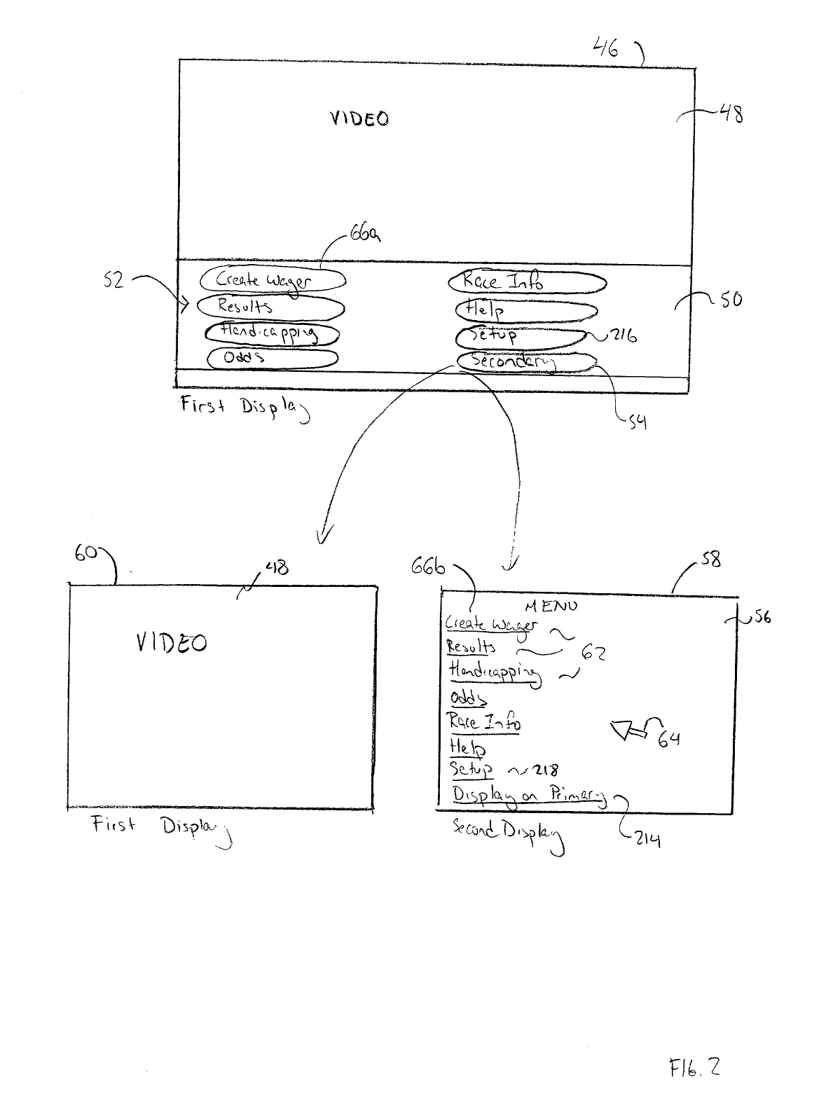

An illustrative menu screen 46 that may be provided by the interactive wagering application is shown in FIG. 2. The interactive wagering application may, for example, be implemented on a set-top box connected to a television and a personal computer or any other suitable arrangement in which two displays are available for viewing by the user. Initially, a screen such as screen 46 may be displayed on a first of the displays (e.g., the television). Screen 46 may contain both video 48 and menu region 50. The format and contents of screens such as screen 46 may be modified to accommodate different platforms such as user computer equipment and user telephone equipment platforms if desired. If desired, video 48 may be video for a television channel (e.g., a wagering television channel). Menu 50 may be an overlay that is displayed on top of video 48.

Menu region 50 may include selectable options 52. For example, menu region 50 may include an option 54 that the user may select to move menu region 50 to a second display. The new menu region is shown as menu region 56 of screen 58 of the second display in the lower right of FIG. 2. At the same time, menu region 50 may be removed from the first display, so that the video 48 for the first display may be displayed without an overlay. The appearance of the first display after menu region 50 has been removed is shown by screen 60 in the lower left of FIG. 2.

The second display may be any suitable secondary display device. For example, the second display may be the monitor of a personal computer. As shown in FIG. 2, a web-like or HTML-like interface display format may be used for the options 62 of menu region 56. The user may select such options by positioning a pointer such as pointer 64 on a desired option using a pointing device such as a mouse, trackball, etc. Other displays may use different display formats and selection arrangements. For example, if the second display is a cellular telephone display, options may be displayed using cellular telephone display formats and may be selected using keys on the telephone. If the second display is a television display, options may be displayed using a format such as that used for region 50 and may be selected using remote control keys or the like, etc.

The options 52 and 62 of FIG. 2 include a create wager option that allows the user to create an electronic wager for submission to transaction processing and subscription management system 24 (FIG. 1). Options 52 and 62 also contain a results option that allows the user to access race results. Options such as a handicapping information option, a race info option, and an odds option may be used to access handicapping information and horse racing statistics and the like. The user may access features related to setup by selecting a setup option. The user may also access help features by selecting a help option.

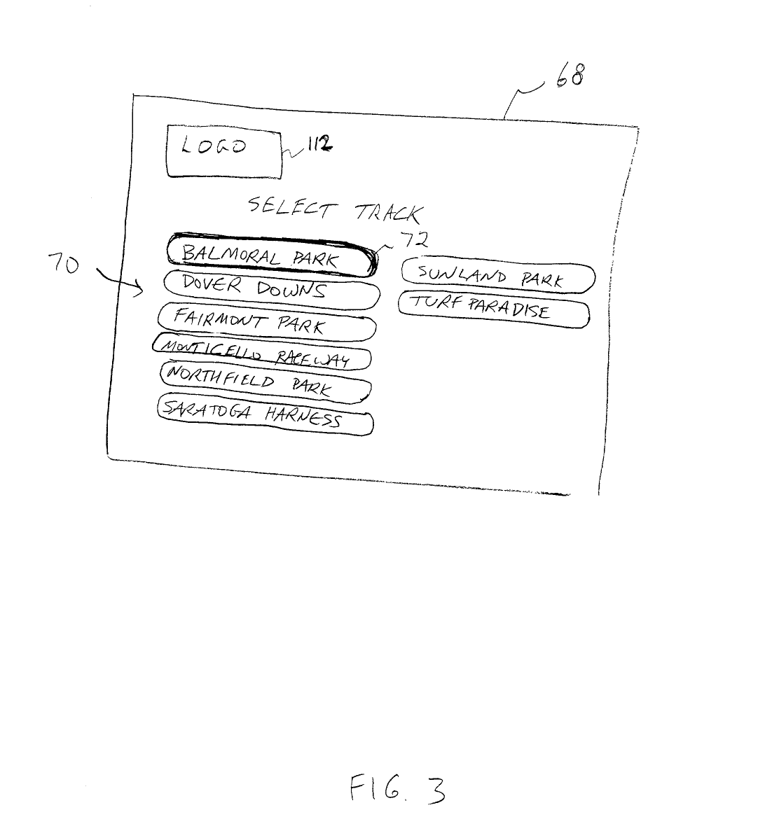

If the user selects an option such as create wager option 66a before region 50 has been removed from screen 46 by selecting option 54, the interactive wagering application may display a screen such as screen 68 of FIG. 3 on the first display. Screen 68 may include a list 70 of tracks from which the user may select a desired racetrack for which to place a wager. For example, the user may select a track name by positioning highlight region 72 using remote control arrow keys and by pressing a remote control OK key or the like.

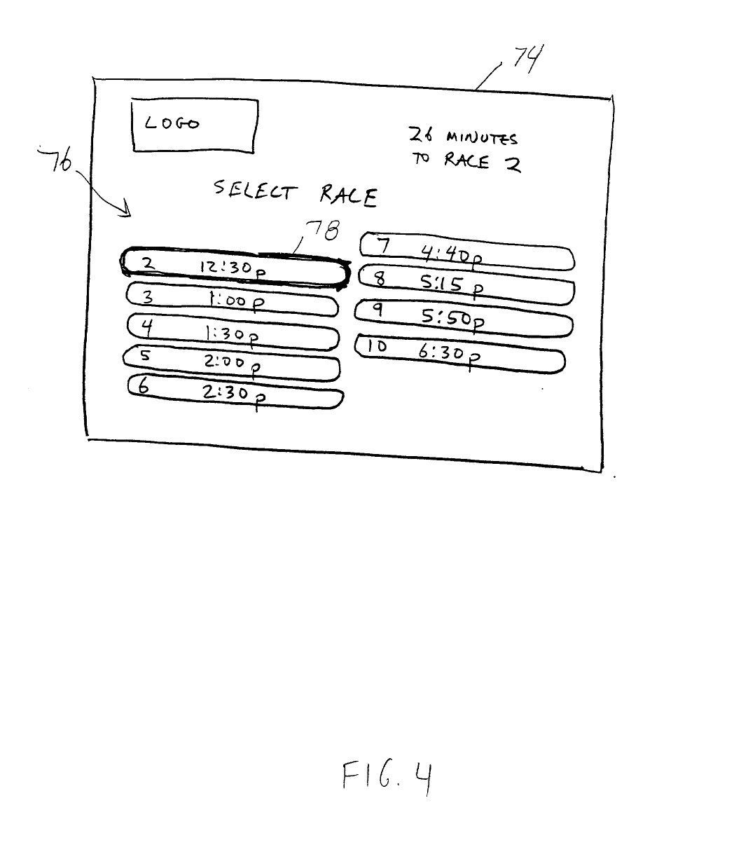

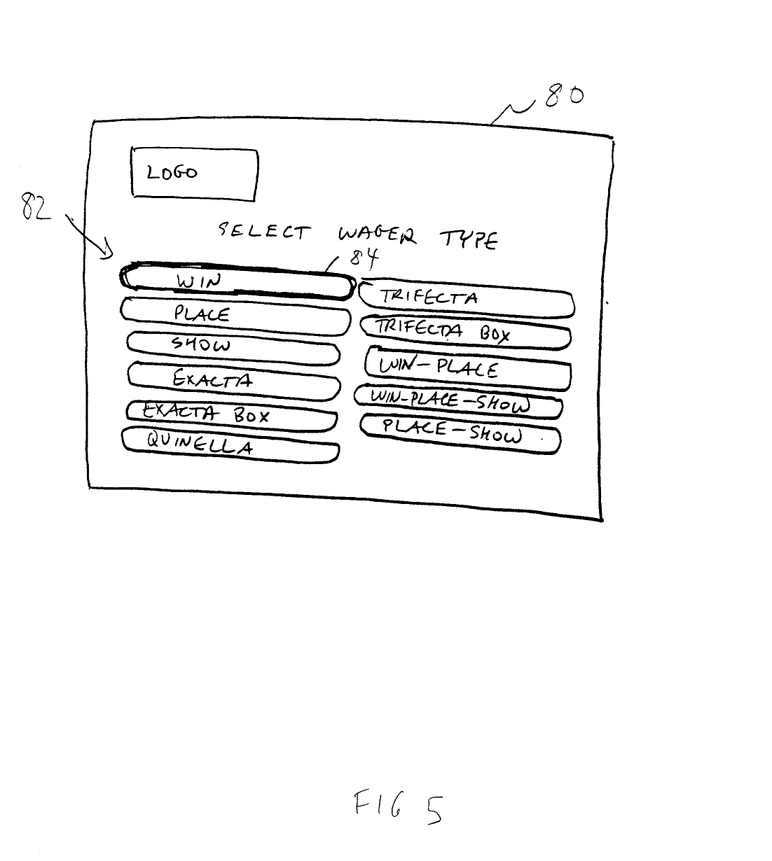

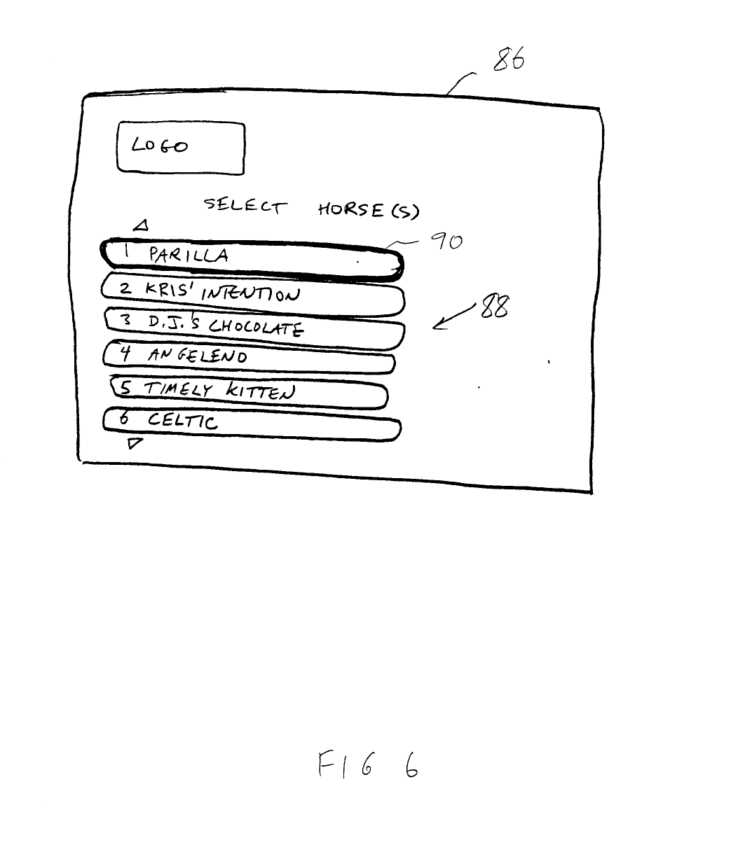

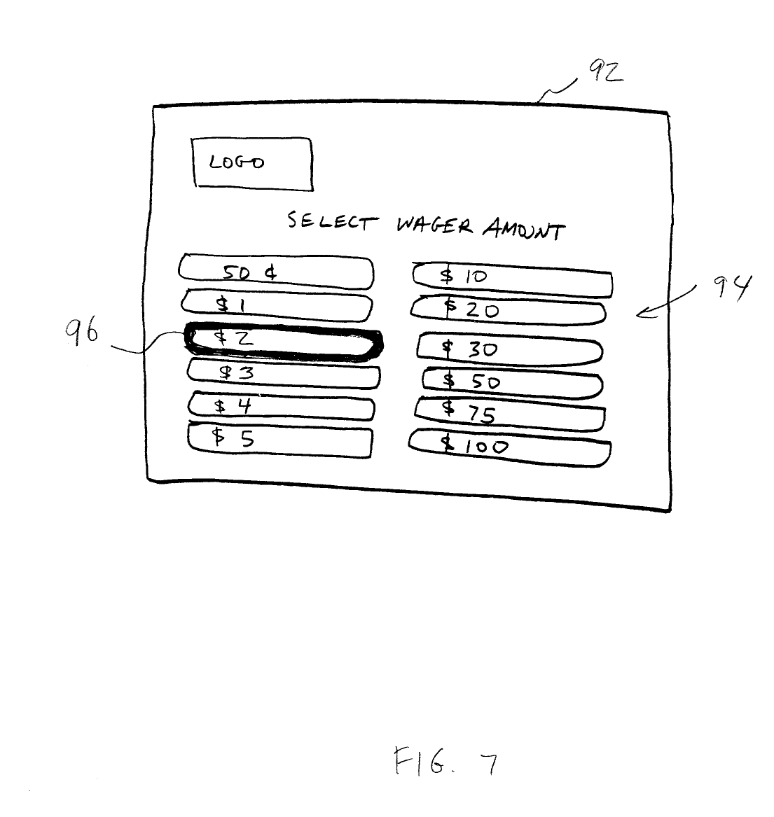

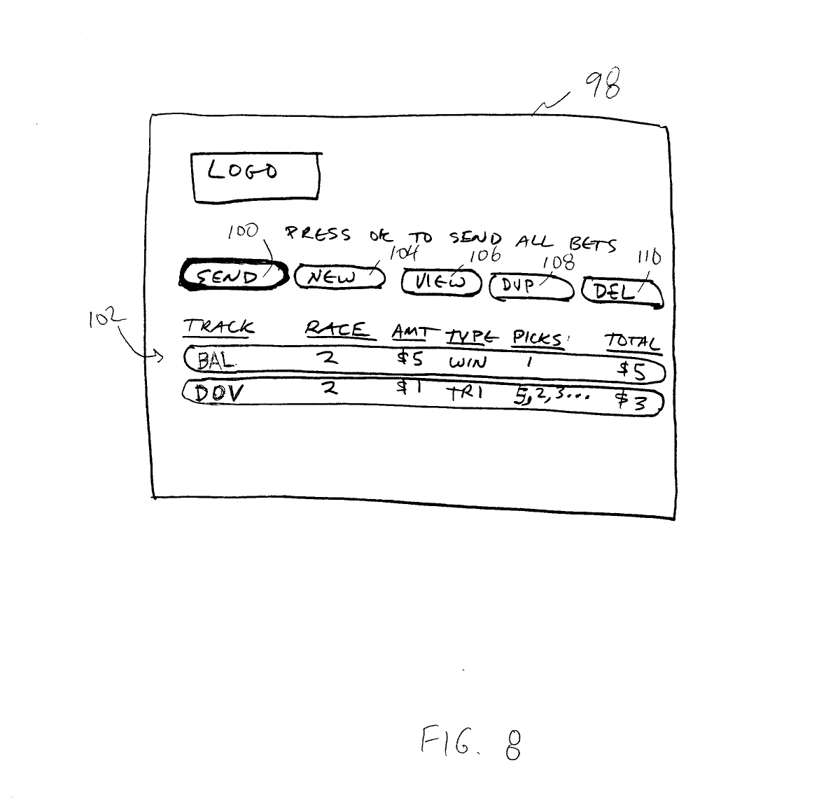

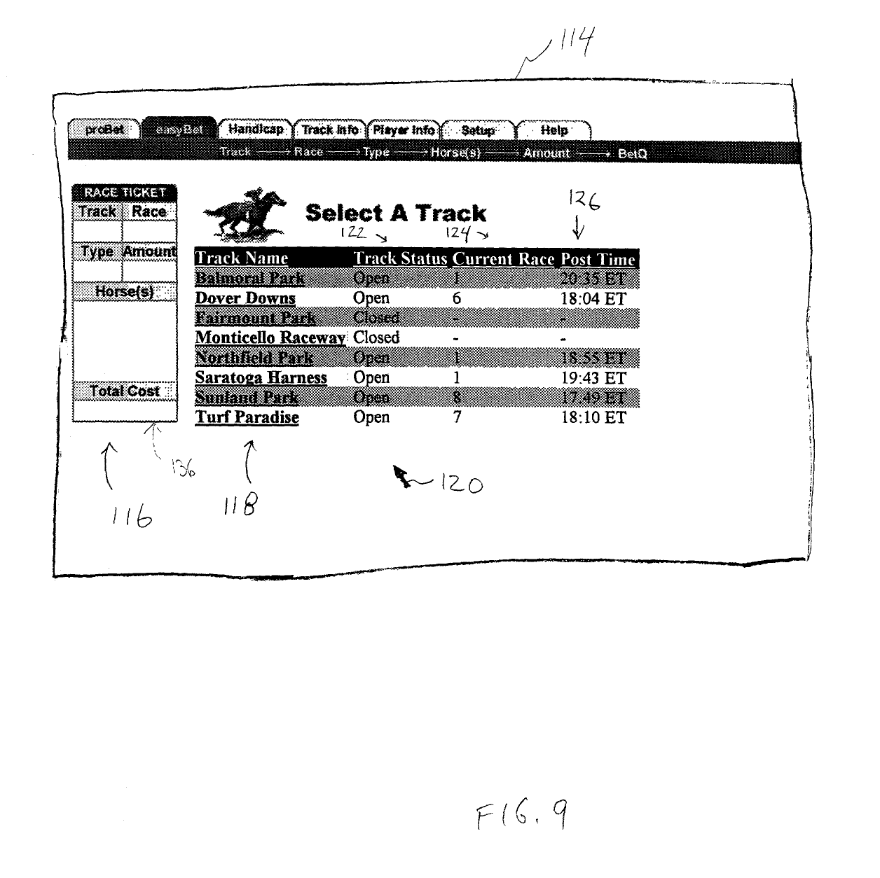

After the user of the interactive wagering application selects a desired racetrack from screen 68, the application may display a race selection screen such as screen 74 of FIG. 4. A list 76 of available races may be displayed. The user may select a desired race using highlight region 78.

When the user has selected a desired race, the interactive wagering application may display a wager type screen such as screen 80 of FIG. 5. Wager type screen 80 of FIG. 5 may include a list 82 of available wager types. The user may select a desired wager type using highlight region 84.

After the user has selected a desired wager type, the interactive wagering application may display a horse selection screen such as horse selection screen 86 of FIG. 6. Horse selection screen 86 may include a list 88 of available horses for the selected race. The user may select one or more horses for the user's wager using highlight region 90.

After selecting the horse or horses for the wager, the user may be presented with a screen such as wager amount selection screen 92 of FIG. 7. Wager amount screen 92 of FIG. 7 may include a list 94 of available wager amounts. Screen 92 allows the user to select a desired amount for the wager using highlight region 96.

When the user selects the wager amount using one of the on-screen options on screen 92, the user may be presented with a screen such as wager queue screen 98 of FIG. 8. The user may use option 100 to submit the wagers in queue 102 to transaction processing and subscription management system 24 (FIG. 1). Option 104 may be used to create a new wager.

The user may select view option 106 when the user desires to view more detailed information regarding a particular wager. Duplicate option 108 may be used to duplicate a particular wager. Delete option 110 may be used to delete a particular option. When any of options 106, 108, or 110 are selected, a highlight region is automatically placed over one of the entries in queue 102 that the user may position with remote control arrow keys or the like to indicate which wager is to be viewed in more detail, duplicated, or deleted.

Screens such as the screens of FIGS. 3-8 may include logos such as logo 112 or other suitable material.

The screens of FIGS. 3-8 provide the user with an interactive opportunity to create a wager for a race. These screens may be displayed on the first display. When the wager has been created and submitted, the interactive wagering screens may be removed and the user returned to normal television viewing.

If the interactive wagering application is displaying interactive wagering content on the second display such as menu 56 of FIG. 2, the user may select create wager option 66b to be presented with an interactive wagering opportunity using the second display while the first display is used entirely to display the television wagering channel or other television or video or other suitable content without obstruction by a menu such as menu 56 of FIG. 2.

For example, when the user selects option 66b, the interactive wagering application may present a screen for the user on the second display such as screen 114 of FIG. 9. Screen 114 may include information 116 on the wager that the user is creating. Information 116 may be presented, for example, in the form of a race ticket such as race ticket region 136. A list 118 of available racetracks may be included in screen 114. The user may use a pointing device such as a mouse, trackball, touchpad, or any other suitable pointing device to position a cursor or pointer 120 on top of a desired item in screen 114. The user may, for example, position pointer 120 on top of a desired racetrack to use in creating a wager.

Screen 114 may include track status information 122 indicating whether certain tracks are open or closed. Current race information 124 may be provided to indicate the current race or next race to be run at each track. Post time information 126 may be provided to indicate how much time remains until the next race at each track is run.

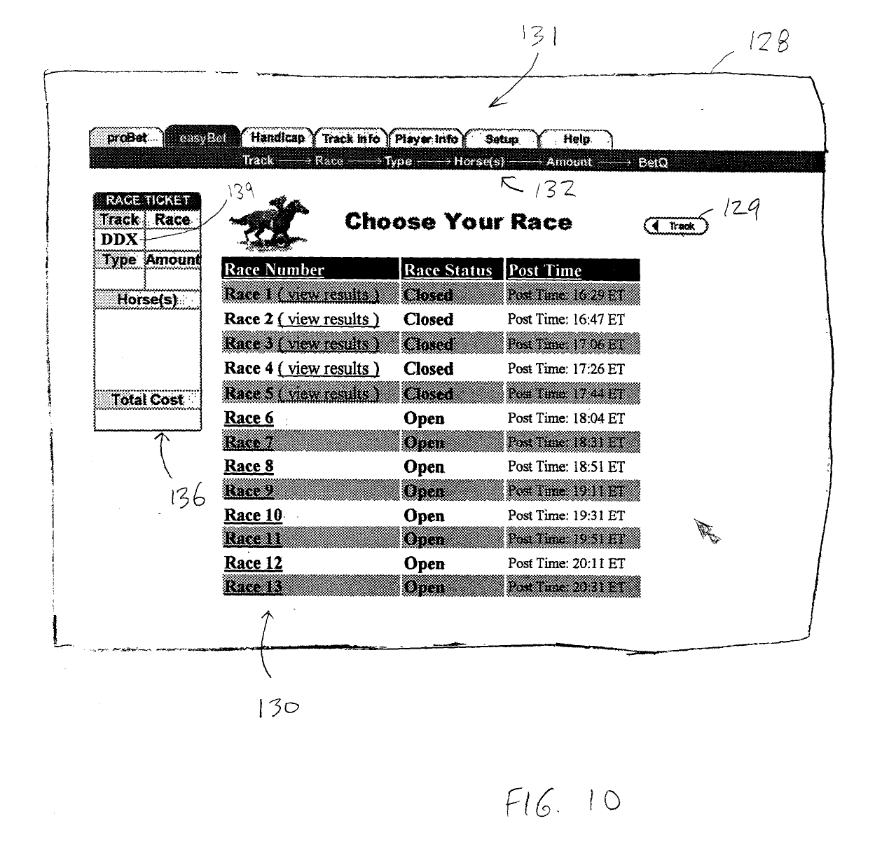

After the user has selected a desired racetrack from the list 118 (FIG. 9) displayed on the second display, the interactive wagering application may display a screen on the second display such as screen 128 of FIG. 10. On screen 128, race ticket region 136 may be updated to include information 139 on which race was selected on screen 114. A list 130 of available races at the selected track may be included on screen 128. The user may select a desired race from list 130 by clicking on the name for the race. If desired, corresponding race status and post time information may be included for each race.

On screen 128 and other such interactive wagering screens, tabs 131 may be used to indicate the user's present location within the interactive wagering application. The user may select from proBet (a streamlined wagering interface for experienced users), easyBet (a more full-featured interface for novice users), Handicap (features that allow the user to obtain handicapping information), Track Info (information on various racetracks), Player Info (features that support wagering by multiple users), Setup (for setting up various settings of the interactive wagering application), and Help (context-sensitive help information).

A bar 132 or other suitable region may be displayed below tabs 131 (or in any other suitable location) that indicates the user's location within the wager creation process. The user's current location (e.g., the race selection menu of screen 128) may be indicated by coloring the appropriate word in the bar (e.g., the word “Race” in the example of FIG. 10). The user may return to track selection screen 114 by selecting option 129.

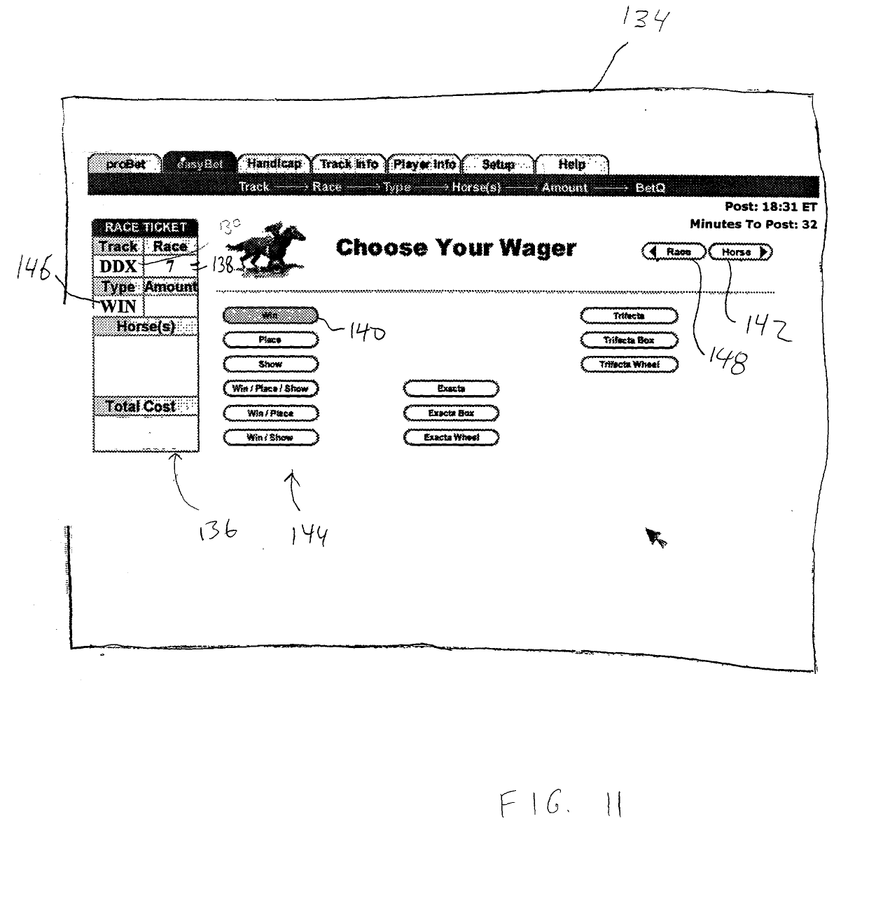

After the user has selected a desired race at the selected racetrack, the user may be presented with a screen such as screen 134 of FIG. 11. Screen 134 may allow the user to select a wager type for the wager. On screen 134, race ticket region 136 may be updated to include information 138 on which race was selected on screen 128. In the example of FIG. 11, the information 138 reflects that the selected race is race No. 7. Information 139 may also be included on the selected track.

If desired, a default wager type may be highlighted on screen 134. In the example of FIG. 11, option 140 for a win wager has been highlighted. If the user wishes to place a win wager, the user may proceed to the horse selection menu by selecting horse option 142. If the user would like to place a different type of wager (e.g., a place wager, a show wager, etc.), the user may select one of the other wager type options 144 by clicking on that option. Information 146 may be provided in race ticket region 136 that indicates the highlighted wager type.

The user may return to race selection screen 128 by selecting option 148.

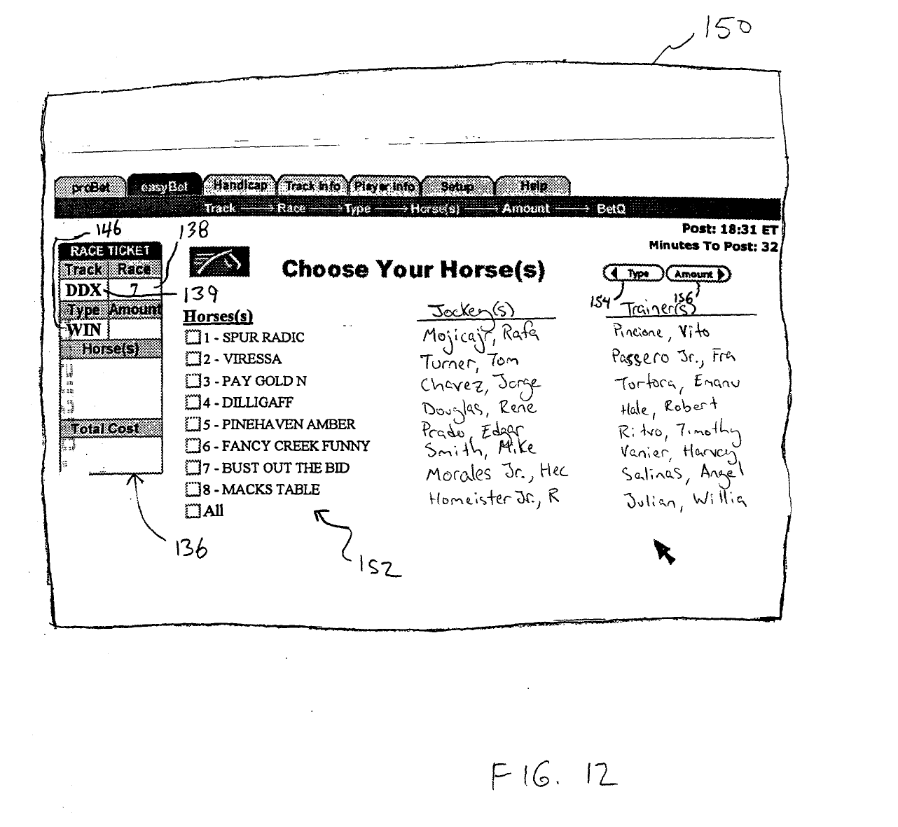

After the user has selected a desired wager type (e.g., a win wager in the example of FIG. 11), the interactive wagering application may present a horse selection screen to the user such as horse selection screen 150 of FIG. 12. Horse selection screen 15 may include horse information, jockey information, trainer information, or any suitable combination thereof. On screen 150, race ticket region 136 may be updated to include information 146 on which wager type was selected on screen 134.

If desired, the user may select one or more horses for the wager by clicking on the appropriate horse options 152.

In the example of FIG. 12, the user may return to wager type selection screen 134 (FIG. 11) by selecting option 154. The user may advance towards completing the wager by selecting amount option 156.

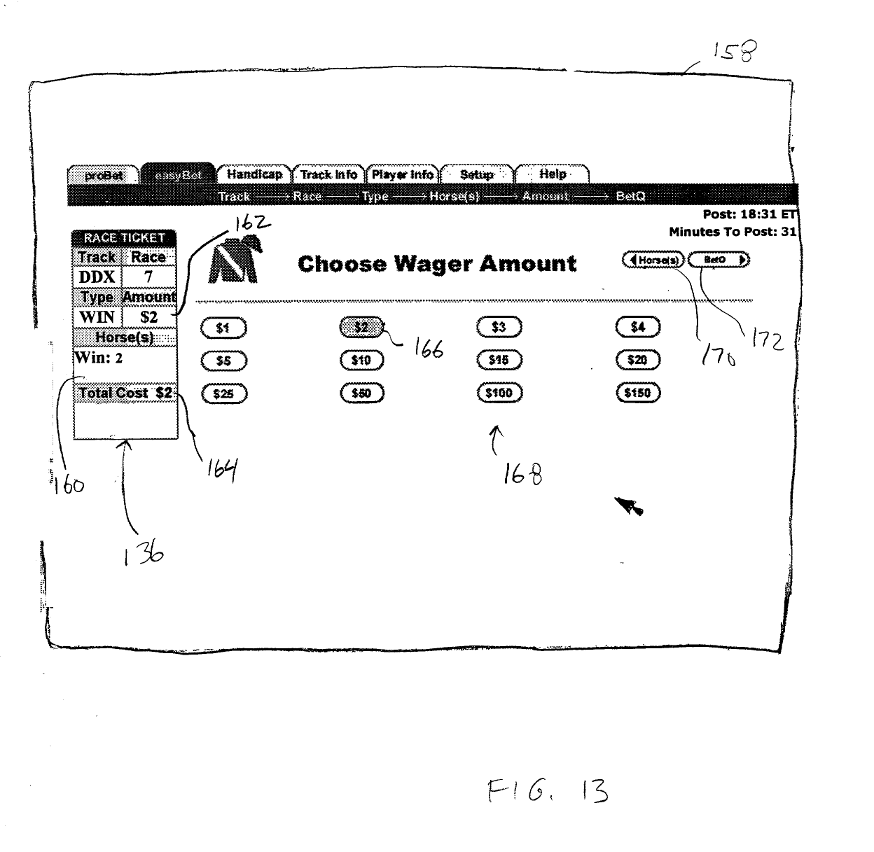

If the user selects amount option 156 of FIG. 12, the user may be presented with a screen such as amount selection screen 158 of FIG. 13. On screen 158, race ticket region 136 may be updated to include information 160 on the selected horse or horses selected on screen 150. In the example of FIG. 13, information 160 reflects that horse number 2 has been selected for the user's win wager.

Race ticket region 136 in FIG. 13 also contains information 162 that reflects the default highlighted wager amount. Information 164 reflects the total cost of the wager, which may differ from the cost represented by information 106 when, for example, multiple horses have been selected for a wager that requires only one horse.

In the example of FIG. 13, $2 option 166 is highlighted by default and information 162 reflects this amount. The $2 amount is merely illustrative. Any suitable amount may be selected as a default. Moreover, no default amount need be selected. The user may be required to select or enter a wager amount.

If the user desires to change the default amount to another amount, the user may select one of the other wager amount options 168.

Option 170 may be provided to allow the user to return to horse selection screen 150.

When the user is ready to place the wager, the user may select bet queue option 172.

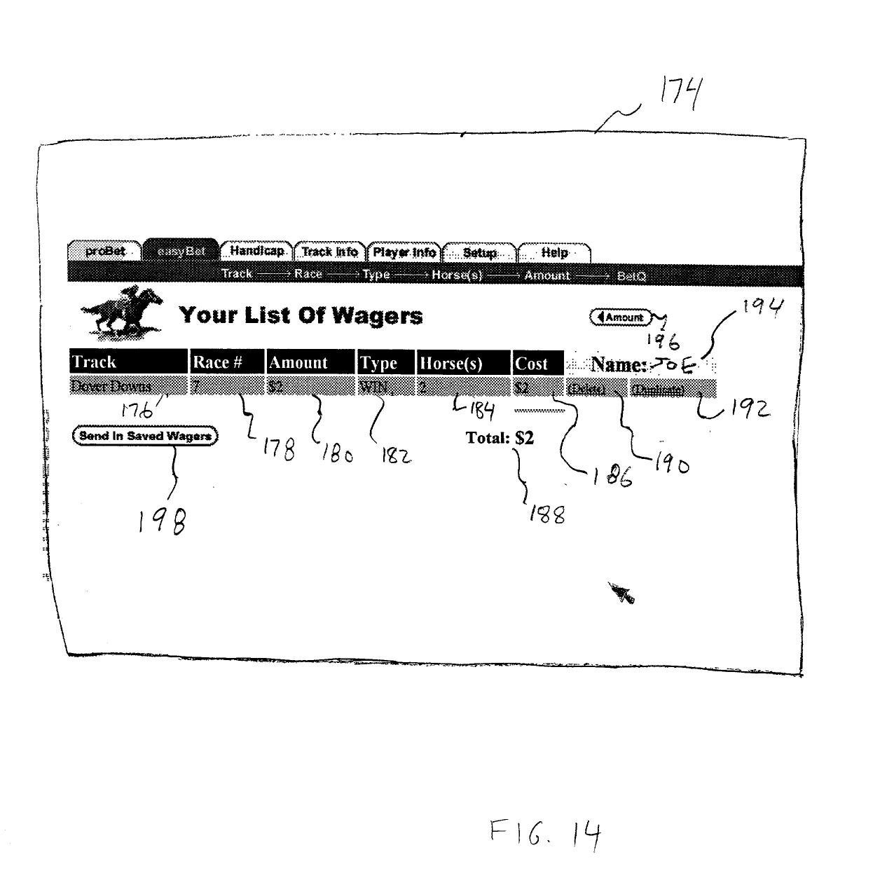

When the user selects bet queue option 172, the interactive wagering application may present a screen such as wager list screen 174 of FIG. 14. Screen 174 may contain information 176 on the selected track for the wager, information 178 on the selected race number for the wager, and information 180 on the selected wager amount for the wager. Information 182 may also be included on the selected wager type for the wager. Information 184 may be presented on which horse or horses have been selected for the wager. If the race involves runners other than horses (e.g., dogs, etc.), the numbers for those runners may be presented instead of horse numbers.

Information 186 on the cost of each wager may be presented in a column. The total cost 188 of all of the wagers added together may also be presented.

Option 190 may be provided to allow the user to delete wagers from the list of screen 174. Duplicate option 192 may allow the user to duplicate a wager.

The interactive wagering application may support multiple users. For example, multiple users in a home may access the interactive wagering application through a common personal computer. Personal identification numbers (PINs) may be created for each user. When the user enters a PIN when signing into the system, the interactive wagering application may look up the user's name and may display the user's name in region 194.

Amount option 196 may be used to return wager amount screen 158 of FIG. 13.

When the user is satisfied with the wagers listed in screen 174, the user may select send in saved wagers option 198. This submits the wagers from the user to transaction processing and subscription management system 24 of FIG. 1. Transaction processing and subscription management system 24 may then process the wager and credit or debit the user's account according to the results of the race.

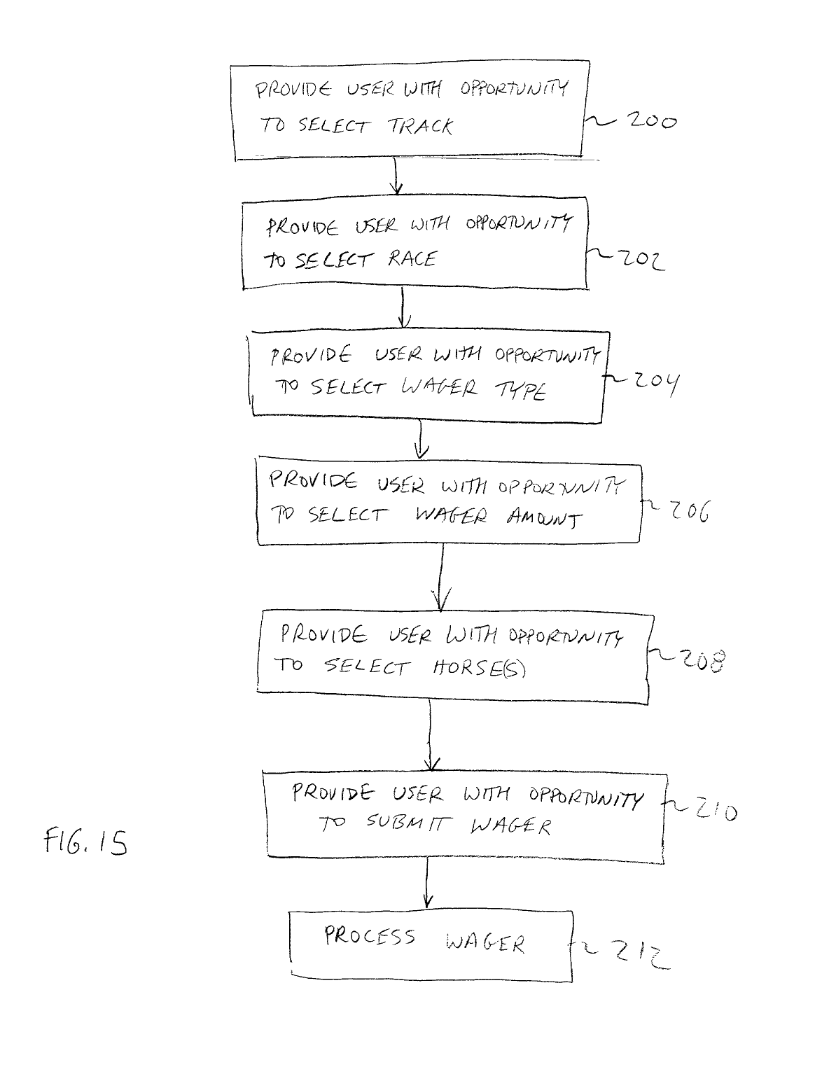

Illustrative steps involved in providing a user with an interactive wagering opportunity are shown in FIG. 15. The steps of FIG. 15 may be performed using an interactive wagering application. If a single display is being used, the interactive wagering application may present on-screen wagering options on the first display (e.g., using an arrangement such as the one shown in FIGS. 3-8). If multiple displays are being used, a first display may be used to display video for a wagering television channel or the like and a second display may be used to present on-screen wagering options (e.g., using an arrangement such as the one shown in FIGS. 9-14).

At step 200, the user may be provided with an opportunity to select a desired track for a wager. For example, a screen including a list of available tracks may be displayed for the user.

After the user has selected a desired racetrack, the user may be provided with an opportunity to select a desired race at that racetrack at step 202. For example, a screen including a list of available races may be displayed for the user.

After the user has selected a desired race, the user may be provided with an opportunity to select a desired wager type for the wager at step 204. For example, a screen including a list of available wager types may be displayed at step 204.

When the user has selected a wager type, the interactive wagering application may provide the user with an opportunity to select a wager amount for the user at step 206.

After the user has selected a wager amount at step 206, the interactive wagering application may provide an opportunity for the user to select a horse or horses for the wager at step 208.

After the horse or horses have been selected at step 208, the user may be provided with an opportunity to submit a wager to transaction processing and subscription management system 24 (FIG. 1) at step 210.

At step 212, the submitted wager may be processed. If the wager is successful, the user's account may be credited. If the wager is unsuccessful, the user's account may be debited.

When the interactive wagering application is configured to display interactive wagering options on the same display as the user's television content as shown by screen 46 of FIG. 2, the user may select secondary option 54 to configure the system to display television content on a first display and interactive wagering content on a second display, as shown by screens 60 and 58 of FIG. 2. To return to the configuration in which both interactive wagering options and television content on the same display, the user may select an option such as display on primary option 214 of FIG. 2.

Another way in which the number of displays that are being used in the system may be configured is through a setup option. The user may access the setup features of the interactive wagering application by selecting options such as setup option 216 or setup option 218 of FIG. 2.

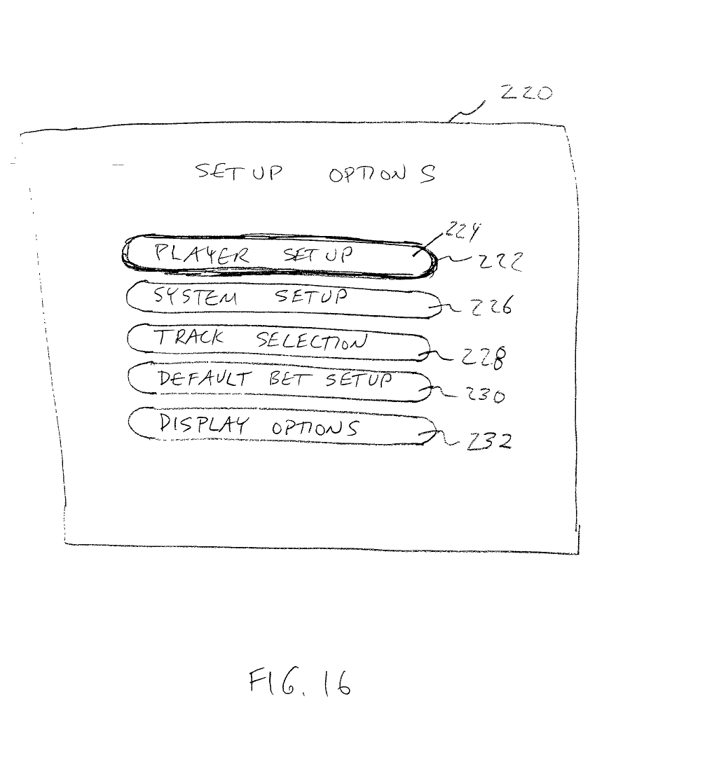

If, for example, the user selects setup option 216, the interactive wagering application may display a screen such as screen 220 of FIG. 16. The user may use remote control arrow keys or the like to position highlight region 222 on top of a desired option. An option may be selected by pressing a remote control OK key or the like once the desired option has been highlighted.

Setup options screen 220 may include player setup option 224. The user may use player setup option 224 to manage functions relating to different users. For example, option 224 may be used to add a new user, to delete a user, to change passwords, etc.

System setup option 226 may be used to configure system parameters such as equipment settings, security settings, etc.

Track selection option 228 may be used to establish user-defined or default tracks.

Option 230 may be used to set up default bet settings.

The user may configure the display options of the system by selecting display option 232.

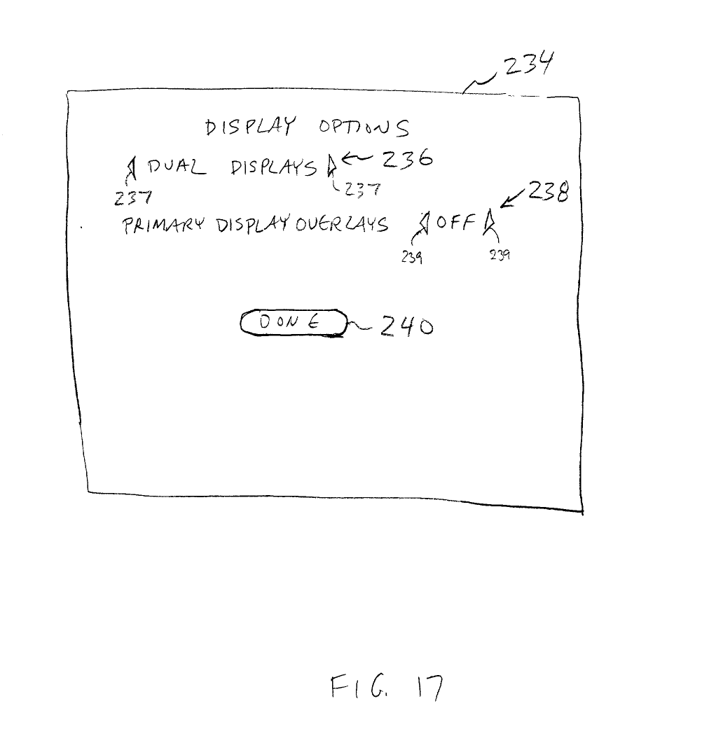

An illustrative screen 234 that may be displayed when the user selects display option 232 of FIG. 16 is shown in FIG. 17. Screen 234 may contain display mode option 236, which the user may use to select how many displays are to be used by the system. For example, the user may use display mode option 236 to select between a single display mode, a dual display mode, or a display mode that supports more than two displays. The user may use remote control left and right arrow keys or the like to select from these different available settings, as indicated by arrows 237.

Primary display overlays option 238 may be set to be on or off. The user may set the primary display overlays option 238 to be on or off using remote control left and right arrow keys as indicated by arrows 239. If the primary display overlays option or other such option is set to “ON” interactive wagering content may be displayed on the primary (first) display. If the primary display overlays option is set to “OFF,” interactive wagering content will not be displayed on the primary (first) display. If desired, the primary display overlays option 238 may be presented to the user only when the dual displays setting has been selected using option 236. This allows the user to turn on the interactive wagering content on the primary display, even when two displays are being used. The default configuration may, however, be for the primary display overlays to be turned off when dual displays are used.

When the user has finished adjusting the display options, the user may select done option 240.

When the user selects setup option 218 of FIG. 2 (e.g., when dual displays are being used), the interactive wagering application may provide the user with options such as the options of FIGS. 16 and 17 on the second display.

Once the system has been configured to support a single or dual displays or more than two displays, the user need not reconfigure the system. The selected number of displays may be used each time the user turns on the system. If desired, the system may automatically determine which displays are turned on or are otherwise active or available for display purposes. The system may then be automatically configured to use, for example, two screens whenever more than one screen is available.

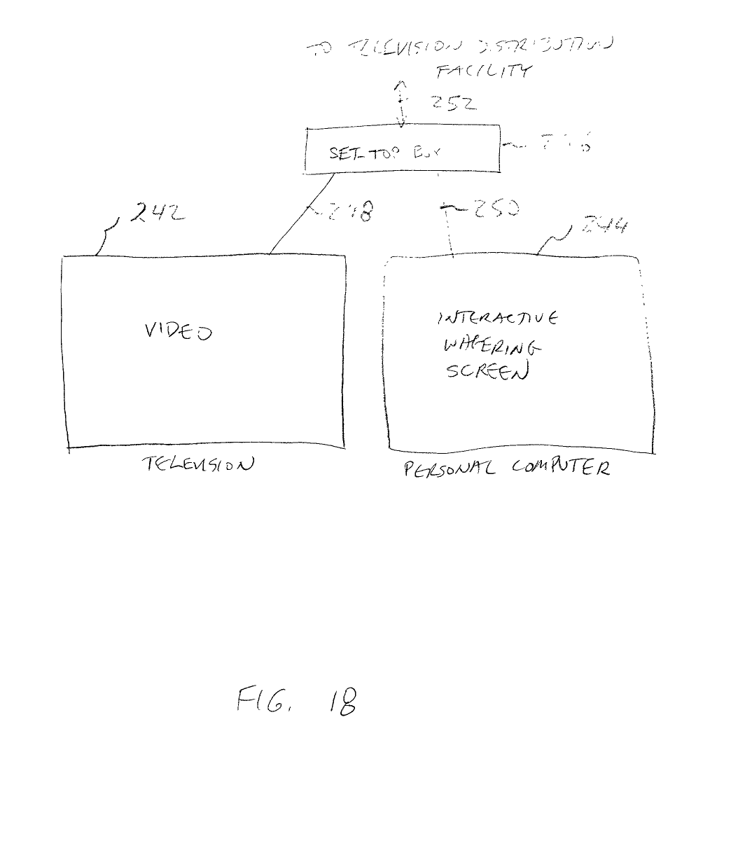

As shown in FIG. 18, the first display and second display may be implemented using a television 242 and a personal computer 244 that are connected to a single set-top box 246. The set-top box 246 may be, for example, a cable set-top box, a WebTV box or other Internet-capable set-top box, a side-car box connected to a standard cable set-top box, a satellite receiver, or any other such suitable equipment.

Television 242 may be a standard television that is connected to set-top box 246 by a coaxial cable or other suitable communications path 248. Set-top box 246 and personal computer 244 may be connected using a telephone line, a FireWire path, a coaxial cable, or any other suitable communications path 250.

The set-top box may be connected to a television distribution facility such as one of television distribution facilities 18 of FIG. 1 using communications path 252 (e.g., a coaxial cable, etc.).

With an arrangement of the type shown in FIG. 18, video may be displayed on television 242 while interactive wagering content may be displayed on the monitor of computer 244. For example, video for a wagering television channel or other television channel may be displayed on television 242. The interactive wagering content displayed on personal computer 244 may include, for example, screens such as those shown in FIGS. 9-14.

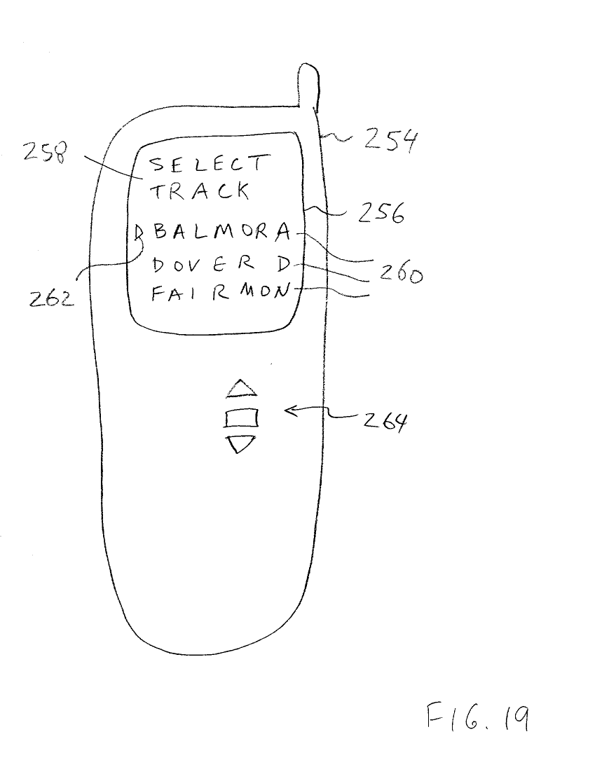

The secondary display device may be a cellular telephone with a display, as shown in FIG. 19. Cellular telephone 254 may have a liquid crystal display (LCD) screen 256. In the illustrative example of FIG. 19, the user is being presented with a track selection menu, as indicated by title 258. The user may select a desired racetrack for a wager from the list of available racetracks 260. The user's current location in the list may be indicated using a highlight or other character such as arrow 262. The user may navigate among the options displayed on screen 256 and may select desired options using keys such as keys 264 or the like.

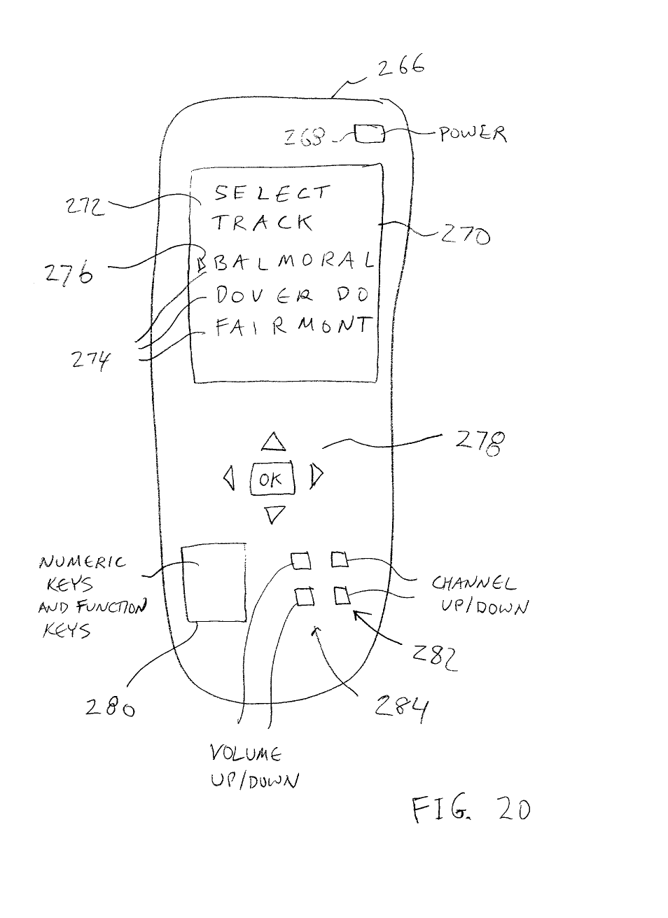

Another type of device that may be used as a secondary display device is a remote control with a display, as shown in FIG. 20. Remote control 266 may have a power button 268 for turning on and off the user's equipment.

Display 270 may be an LCD display or other suitable display. In the example of FIG. 20, the screen being displayed on display 270 is a track selection screen, as indicated by title 272. The user may begin the wager creation process by selecting from various available racetracks 274. The user's current location in the list may be indicated using a highlight or other character such as indicator 276. Navigation keys such as keys 278 may be used to move within the displayed options on the second display (display 270) and within various on-screen options displayed on the first display (e.g., a television display). Remote control 266 may also contain numeric keys and function keys 280, channel up/down keys 282, and volume up/down keys 284.

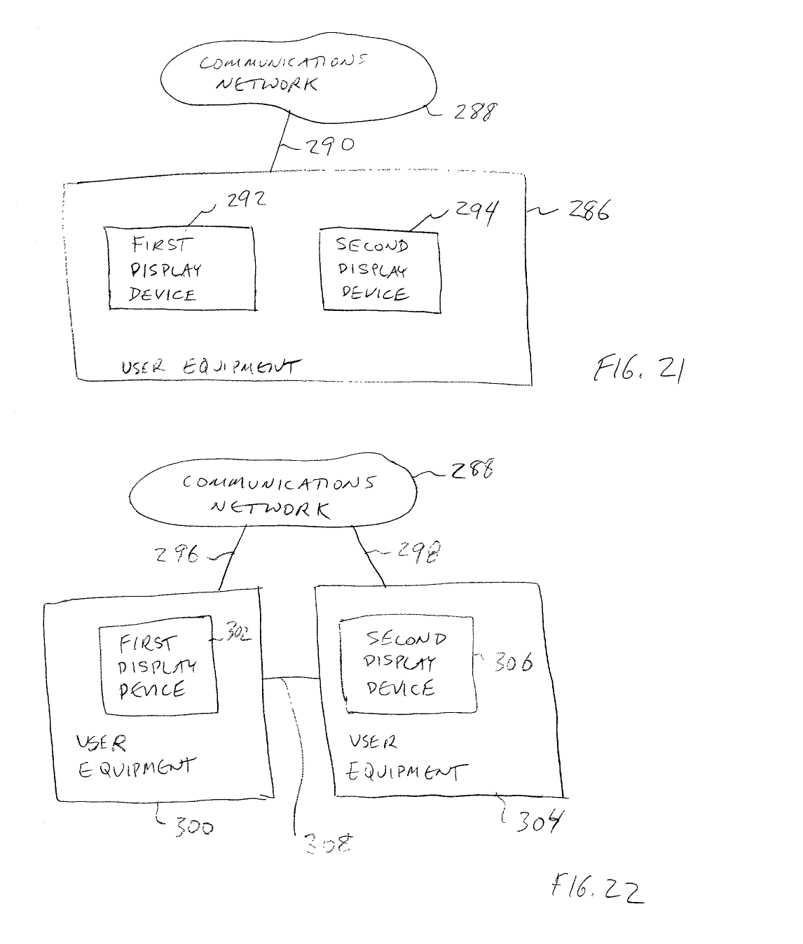

If desired, the first and second display devices may be part of the same user equipment, as shown in FIG. 21. User equipment 286 may communicate with communications network 288 over communications path 290. Communications path 290 may be any suitable communications link such as any of the communications links 44 of FIG. 1. Communications network 288 may be any suitable communications path or network that connects user equipment 286 to the components of system 10 (FIG. 1) such as transaction processing and subscription management system 24 that are used to provide racing data to the user and that are used to process electronic wagers from the user. Display devices 292 and 294 may be any suitable displays that are part of the same user equipment. For example, display device 292 may be a television connected to a set-top box in user equipment 286 and display device 294 may be a remote control with a display.

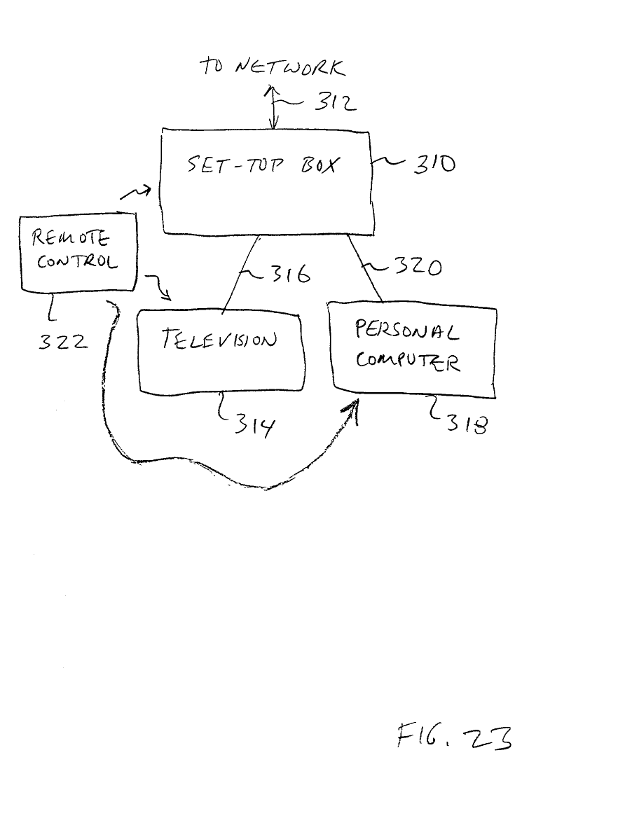

Another suitable arrangement is shown in FIG. 22. In the arrangement of FIG. 22, two user equipment devices are used, each of which has a corresponding display. The user equipment devices communicate with communications network 288 over paths 296 and 298, which may be any suitable communications paths such as the paths 44 of FIG. 1.

User equipment device 300 may include a first display device 302. User equipment device 304 may include a second display device 306. User equipment 300 may be, for example, a set-top box connected to a television that serves as display device 302. User equipment 304 may be, for example, a personal computer with a monitor that serves as display device 306.

As shown in FIG. 22, user equipment 300 may communicate with user equipment 304 using a direct communications path such as path 308. Communications path 308 may be any suitable communications path such as the paths 44 of FIG. 1, a FireWire path, a coaxial cable path, a telephone line path, etc. Path 308 may be, for example, located in the same room of the user's home as user equipment 300 and user equipment 304.

Another way in which user equipment 300 and 304 may communicate with one another is over an indirect communications path or link such as paths 296 and 298 linked through network 288. As an example, network 288 may include a cable system headend. Path 296 may be a cable path to a server at the cable system headend. Path 298 may be the same cable path or a separate cable or telephone line path connected to the server. These are merely illustrative examples. Any suitable direct or indirect links may be used to connect the user equipment that contains the first and second display devices.

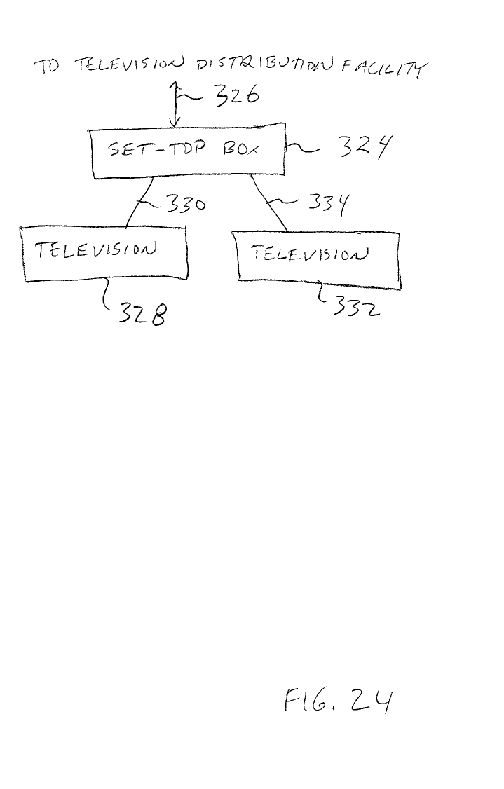

As shown in FIG. 23, a two-display configuration may also include a remote control that controls each of the components in the system. Set-top box 310 may be connected to a communications network using path 312. The network may include components such as those shown in FIG. 1 for connecting set-top box 310 to transaction processing and subscription management system 24. Path 312 and the paths within the network may be any suitable communications paths such as paths 44 of FIG. 1.

Set-top box 310 may be connected to television 314 using communications path 316 (e.g., a coaxial cable or other path such as one of paths 44). Set-top box 310 may be connected to personal computer 318 using communications path 320 (e.g., a coaxial cable or telephone wire or other path such as one of paths 44). Remote control 322 may communicate with set-top box 310, television 314, and personal computer 318. Remote control 322 may be, for example, an infrared remote control.

If desired, two televisions may be used as the first and second display devices. This is shown in FIG. 24. Set top box 324 may be connected to a communications network using path 326. The network may include components such as those shown in FIG. 1 for connecting set-top box 324 to transaction processing and subscription management system 24. Path 326 and the paths within the network may be any suitable communications paths such as paths 44 of FIG. 1.

Set-top box 324 may be connected to television 328 using communications path 330 (e.g., a coaxial cable or other path such as one of paths 44). Set-top box 324 may be connected to television 332 using communications path 334 (e.g., a coaxial cable or other path such as one of paths 44). An infrared remote control or the like may be used to control the operation of set-top box 324 and televisions 328 and 332.

With the arrangement of FIG. 24, a television channel (e.g., a wagering television channel) may be displayed on television 328 while interactive wagering opportunities are displayed on television 332 (e.g., using screens such as the screens of FIGS. 3-8).

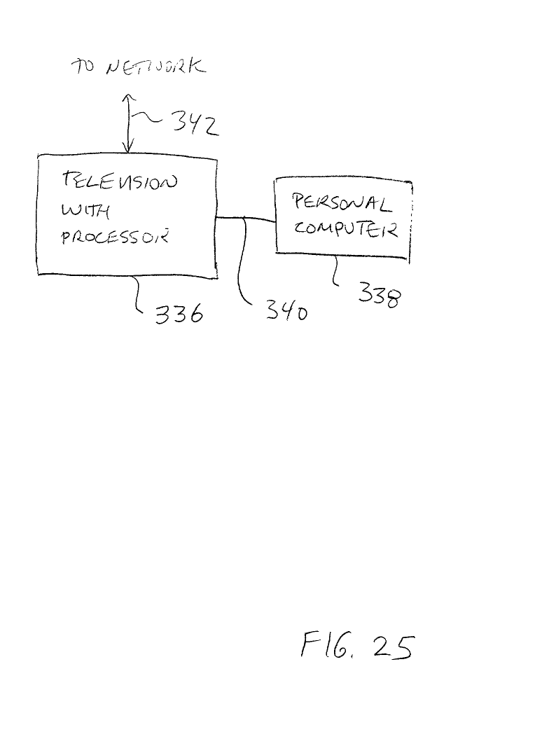

If desired, a television may be used that includes a processor or other embedded control electronics that perform the functions of a set-top box. As shown in FIG. 25, such a television 336 may be connected to a second display device such as a personal computer 338 or any other suitable equipment. Television 336 and computer 338 may be connected using a communications path 340 such as a FireWire connection, a telephone wire path, a coaxial cable, or any other suitable path such as the paths 44 of FIG. 1. Set-top box may be connected to the network using path 342.

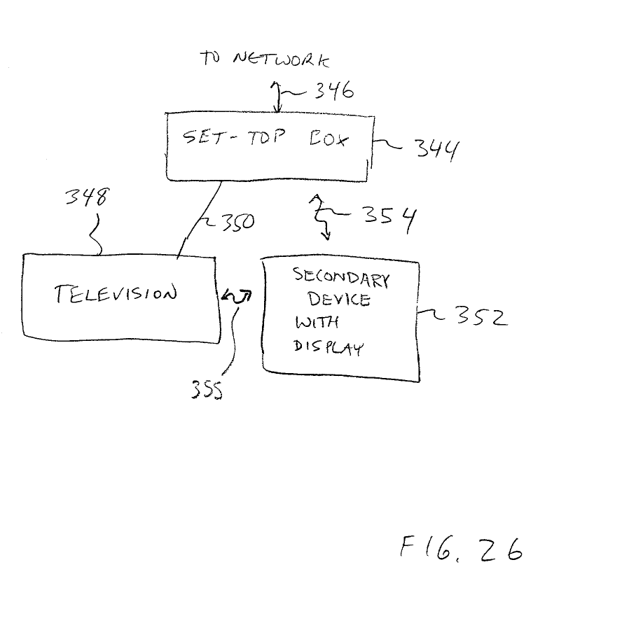

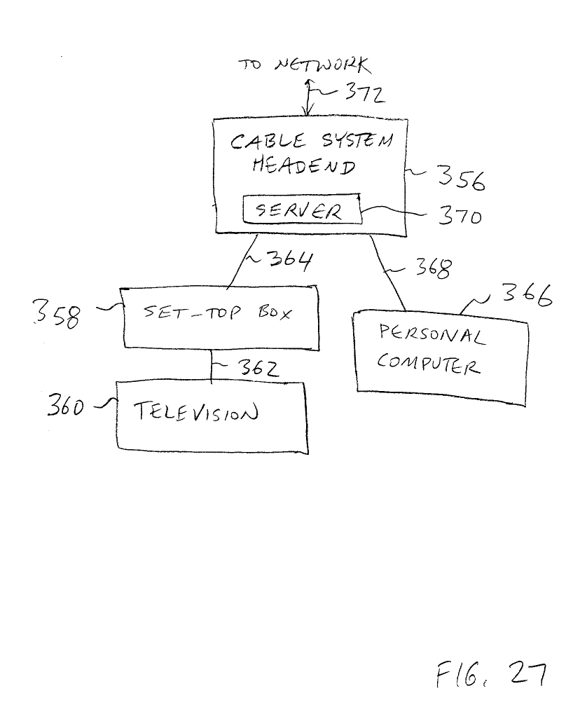

Wireless paths may be used to interconnect the components of the user's equipment. An illustrative example is shown in FIG. 26. In the FIG. 26 arrangement, set-top box 344 may be connected to the network using path 346. Television 348 may be connected to set-top box 344 using path 350. Secondary device with display 352 may be connected to set-top box 344 using wireless path 354. Secondary device with display 352 may be any suitable user equipment such as a remote control, a personal digital assistant, a cell phone, an electronic book, etc. Secondary device with display 352 may also be connected to television 348 using wireless path 355. Although path 355 is shown as a wireless path, any suitable path (e.g., a direct path) may be used.

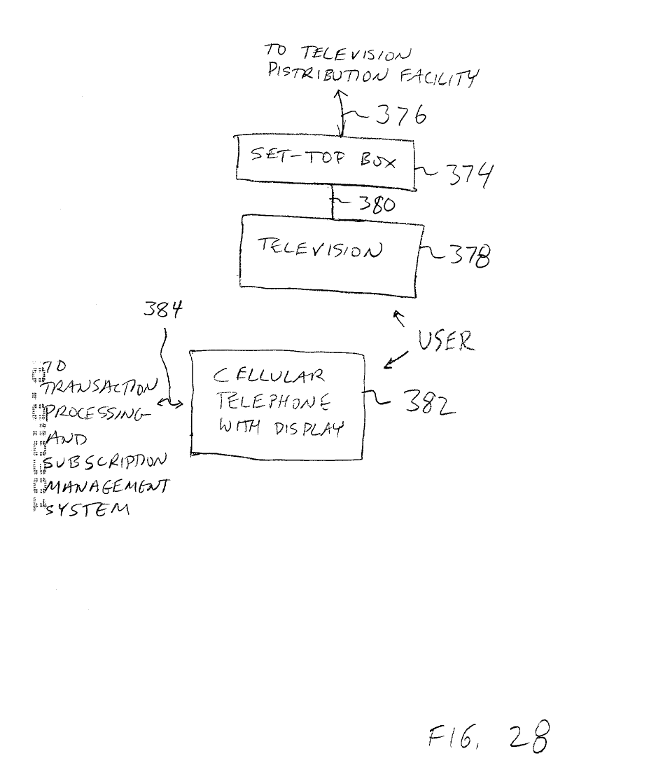

In the arrangement of FIG. 26, set-top box 344 and remote control 352 may communicate over a direct wireless path 354. An arrangement in which a first user equipment device communicates with a second user equipment device over an indirect link is shown in FIG. 27. Set-top box 358 may be connected to television 360 over a communications path 362 such as a coaxial cable or other suitable path. A coaxial cable or other suitable path 364 (e.g., a path or combination of paths such as paths 44 of FIG. 1) may be used to connect set-top box 358 (which may be in the user's home) to cable system headend 356. Cable system headend 356 (which may be located remote from the user's home) may have a server 370. Personal computer 366 may communicate with cable system headend 356 over a communications link 368. Cable system headend 356 may communicate with the network (and through the network to components of the wagering system such as transaction processing and subscription management system 24) using communications path 372.

The user may watch television on television 360. Set-top box 358 may be used to tune to a desired television channel from a plurality of channels provided from cable system headend 356 on path 364. When the arrangement of FIG. 27 is in a single-display mode, interactive wagering content may be displayed by the interactive wagering application on television 360 (e.g., as an overlay on top of television content or in place of television content, etc.). When the arrangement of FIG. 27 is in a dual-display mode, set-top box 358 may be used to tune to a desired television channel that may then be displayed on television 360. Personal computer 366 may be used to view interactive wagering content. The interactive wagering content may be provided over communications path 368. The interactive wagering application that is used to display interactive wagering content on the displays of television 360 and personal computer 366 may be implemented using software that runs on set-top box 358, server 370, or personal computer 366, or any suitable combination of these platforms. For example, a client-server arrangement may be used in which server 370 acts as a host processor for the interactive wagering application and set-top box 358 and personal computer 366 act as client processors. When the user interacts with either of the client processors, the operation of the other client processor may be controlled using an indirect path through server 370.

If a cellular telephone such as cellular telephone 254 of FIG. 19 is used as a second display device, an indirect path for communications between the cellular telephone 254 and the first display device may be formed based on using a wireless cellular communications path. This type of arrangement is shown in FIG. 28. Set-top box 374 may communicate with one of television distribution facilities 18 using any suitable communications path 376. Set-top box 374 may be connected to television 378 using a coaxial cable or other suitable path 380. The user may interact with the interactive wagering application using an infrared remote control to send commands to set-top box 374. Interactive options may be displayed on television 378 when the system is operating in a single-display mode.

When it is desired to operate the equipment of FIG. 28 in a dual-display mode, the user may select appropriate options (e.g., options such as option 54 of FIG. 2 or appropriate setup options, etc.). Set-top box 374 may then be used to tune to certain television channels for display on television 378 and cellular telephone 382 may be used to display interactive wagering opportunities for the user. The operation of set-top box 374 and cellular telephone 382 may be coordinated using an indirect link. If desired, a server (e.g., a server such as a server implemented as part of computer equipment 26 of FIG. 1) may be used to support the interactive wagering application. The user may interact with the server using cellular telephone 382. As the user takes certain actions with set-top box 374 (e.g., by tuning to a particular channel or the like), the server may provide certain corresponding content or options to the user at the cellular telephone. Cellular telephone 382 may communicate with transaction processing and subscription management system 24 using any suitable communications path 384.

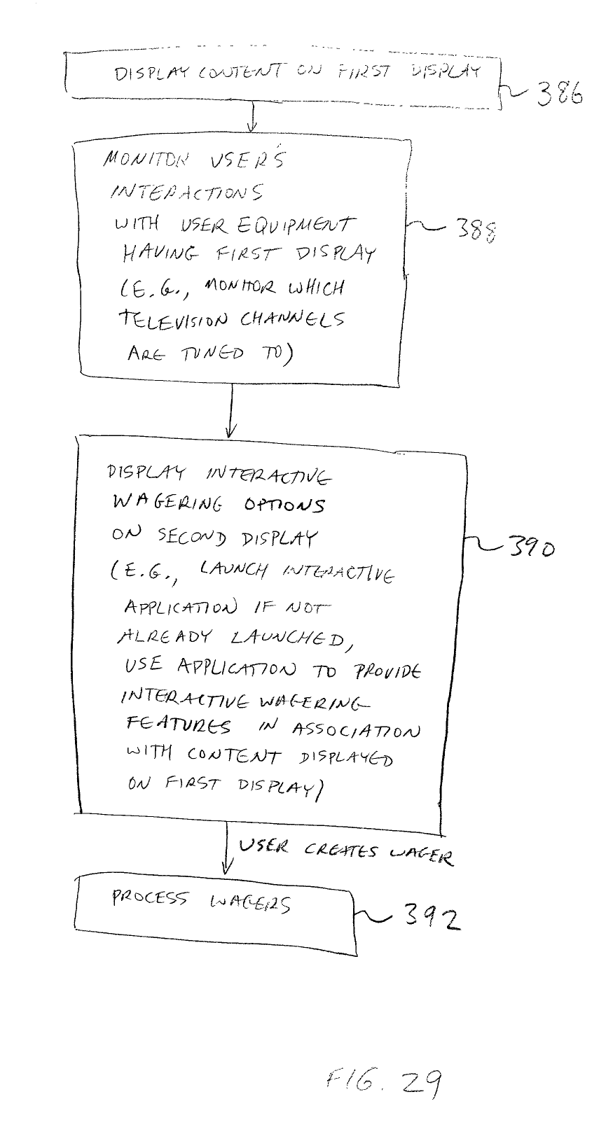

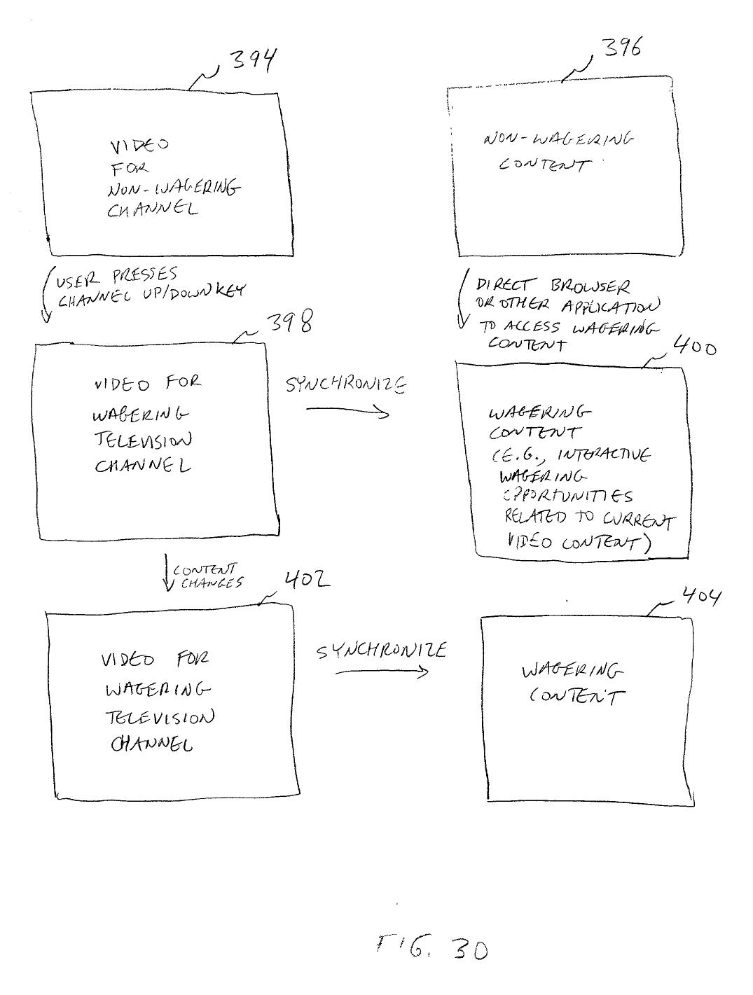

Illustrative steps involved in supporting a multiple-display interactive wagering environment are shown in FIG. 29. At step 386, content may be displayed on the first display. The content on the first display may be, for example video content such as television content. The television content may be for a wagering television channel provided by video production system 14 (FIG. 1). The user may use user equipment such as a set-top box or any other suitable equipment to receive the video (e.g., to tune to the appropriate television channel).

At step 388, the user's interactions with the user equipment that has the first display may be monitored. For example, the television channels to which the user tunes may be monitored. This may allow the interactive wagering application to provide particular features related to these channels.

At step 390, the interactive wagering application may display interactive wagering options on the second display. If the interactive wagering application had not been previously running, the interactive wagering application may be automatically launched at step 390. While the interactive wagering application is displaying interactive wagering options on the second display at step 390, the video or television content is being displayed on the first display at step 390. The options being displayed on the second display may be synchronized with the channels or content being displayed on the first display.

At step 392, after the user has created an electronic wager by interacting with the options displayed on the second display and has submitted the electronic wager to transaction processing and subscription management system 24 (FIG. 1), the wagers may be processed by transaction processing and subscription management system 24.

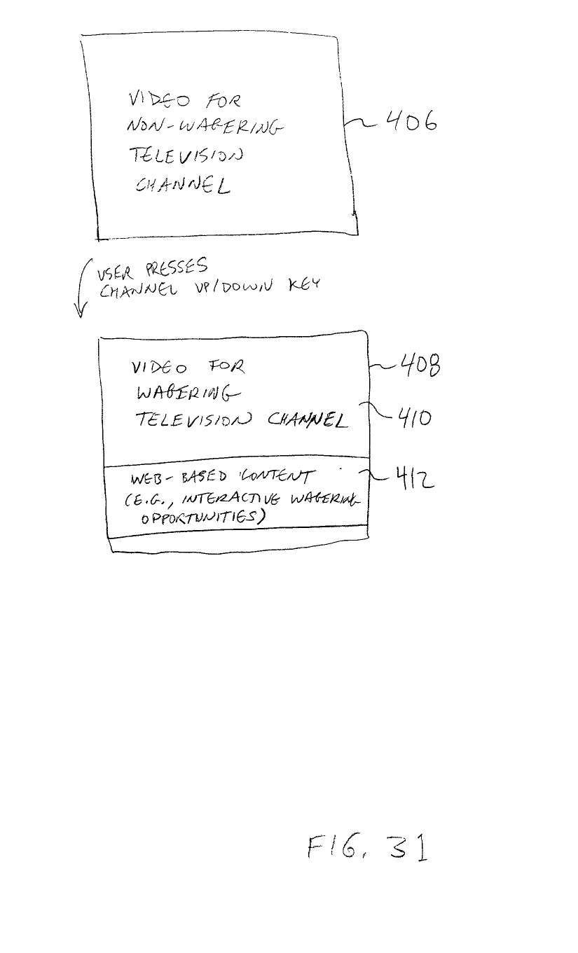

FIG. 30 shows how wagering content may be provided on the second display that is synchronized with respect to the first display. In the example of FIG. 30, the first display (shown in the left column) may be a television connected to a set-top box. The second display (shown in the right column) may be the monitor of a personal computer. These are merely illustrative examples. Any suitable types of user equipment may be used.

Initially (in the top row of FIG. 30), any suitable content such as video for a non-wagering television channel may be displayed in screen 394 on the first display. Any suitable content (e.g., non-wagering content) may be displayed in screen 396 on the second display.

As shown in the second row of FIG. 30, the user may interact with the equipment that includes the first display using channel up/down keys on a remote control or the like to tune to a wagering television channel. Video for the wagering television channel may be displayed in screen 398 on the first display. When it is determined that the user has tuned to the wagering television channel, the interactive wagering application may launch a web browser or the like (if not already launched) and may direct the web browser to access wagering-related content. The wagering content may be displayed in screen 400 on the second display. If desired, the wagering content displayed in screen 400 may be synchronized with the wagering content displayed in screen 398. For example, if an announcer on the wagering television channel displayed on screen 398 is discussing a particular race, interactive wagering options may be displayed on screen 400 that allow the user to create a wager for that race. The synchronization of the content on the first and second displays may be accomplished by sending signals between the equipment that includes the first display and the equipment that includes the second display. The signals may be sent over a direct or indirect communications link. A server (e.g., a server at transaction processing and subscription management system 24, a server at a television distribution facility, or any other suitable server) may be used to coordinate the content displayed on the first and second displays.

Screens 402 and 404 in the bottom row of FIG. 30 show how the video content for the wagering television channel that is displayed using the first display may continue to remain synchronized with the wagering content that is displayed using the second display, even as the video content on the first display changes.

If desired, a web browser may be used to display interactive wagering content on a display. The interactive wagering content may be provided over the Internet or the like. This content may be displayed on the same display as a television channel or other video. The web browser may be a “chromeless” web browser that does not display forward and back buttons or other navigational buttons or controls but only displays web content.

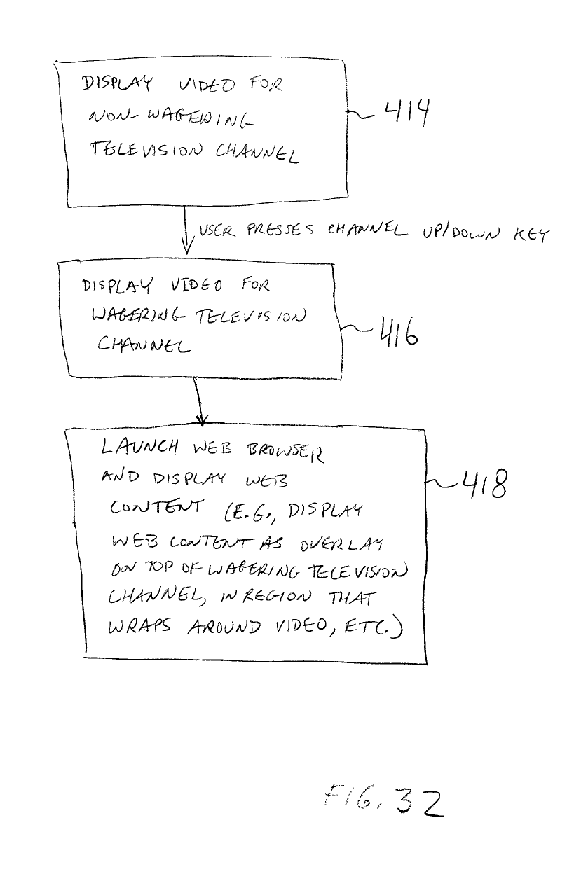

An illustrative arrangement of this type is shown in FIG. 31. Content may be displayed on screen 406 of a display (e.g., a television or a computer monitor or any other suitable equipment with a display). The content that is displayed on screen 406 may be, for example, video for a non-wagering television channel.

When the user presses a channel up or down key on a remote control, screen 408 may be presented to the user. Screen 408 may include a video region 410 that includes video for a wagering television channel. The interactive wagering application (or any other suitable interactive application) may detect when the user has tuned to the wagering television channel (e.g., by monitoring the state of the television tuner in a set-top box or personal computer or other user device and by comparing this information to the known channel location of the wagering television channel). Web-based content may then be automatically displayed on screen 408 (e.g., in a region such as region 412). For example, interactive wagering opportunities may be provided. The interactive wagering opportunities may allow the user to create and submit wagers to transaction processing and subscription management system 24 of FIG. 1. The user may interact with the content in region 412 using a remote control or any other suitable user input device that communicates with the user equipment used to display screen 408.

Illustrative steps involved in displaying web and television wagering-related content on the same display are shown in FIG. 32. At step 414, video for a non-wagering television channel or other suitable content may be displayed on the display of user equipment such as user television equipment, user computer equipment, or user telephone equipment. A user may change the displayed content (e.g., by pressing a remote control channel up or down key or the like) so that video for the wagering television channel is displayed at step 416.

At step 418, a web browser may be launched. The web browser may be used to display web content as an overlay on top of the video for the wagering television channel or in a wrap-around region, etc.

The foregoing is merely illustrative of the principles of this invention and various modifications can be made by those skilled in the art without departing from the scope and spirit of the invention.

What is claimed is:

1. A method for using two displays and an interactive wagering application to present a user with video content and interactive wagering opportunities for races that are to be run, comprising:
displaying the video content for the user on a first of the displays; and
simultaneously displaying the interactive wagering opportunities for the user on a second of the two displays, wherein the video content and the interactive wagering opportunities are synchronized.

2. The method defined in claim 1 further comprising synchronizing the video content and the interactive wagering opportunities using a direct communications link between equipment for the first display and equipment for the second display.

3. The method defined in claim 1 further comprising synchronizing the video content and the interactive wagering opportunities using an indirect communications link between equipment for the first display and equipment for the second display.

4. The method defined in claim 1, wherein the races involve runners that are horses.

5. The method defined in claim 1 further comprising providing the user with an opportunity to use the interactive wagering application to select a racetrack for the wager.

6. The method defined in claim 1 further comprising providing the user with an opportunity to use the interactive wagering application to select a race for the wager.

7. The method defined in claim 1 further comprising providing the user with an opportunity to use the interactive wagering application to select a wager type for the wager.

8. The method defined in claim 1 further comprising providing the user with an opportunity to use the interactive wagering application to select a wager amount for the wager.

9. The method defined in claim 1 further comprising providing the user with an opportunity to use the interactive wagering application to select a runner or runners for the wager.

10. The method defined in claim 1, wherein the races involve runners, the method further comprising:
displaying content on a particular race as the video content on the first display; and
simultaneously displaying content on the second display that provides the user with an opportunity to create a wager for that particular race.

11. The method defined in claim 1 further comprising:
providing the user with an option on the first display; and
displaying the interactive wagering opportunities on the second display in response to the user selecting the option on the first display.

12. The method defined in claim 1 further comprising:
providing the user with an option on the second display; and
displaying the interactive wagering opportunities on the first display in response to the user selecting the option on the second display.

13. The method defined in claim 1 further comprising:
providing the user with an option on the second display; and
displaying the interactive wagering opportunities on the first display as an overlay on top of the video on the first display in response to the user selecting the option on the second display.

14. The method defined in claim 1 further comprising:
providing the user with an option on the second display; and
displaying the interactive wagering opportunities on the first display as a wrap-around region on the first display in response to the user selecting the option on the second display.

15. The method defined in claim 1, wherein the video content is a wagering television channel, the method further comprising:
using a set-top box to tune to the wagering television channel; and
using a personal computer monitor attached to a computer to display the interactive wagering opportunities on the second display.

16. The method defined in claim 1, wherein the video content is television, wherein the first display is associated with a television, and wherein the second display is included in user equipment, the method further comprising:
allowing the user to tune between different television channels;
displaying the television channel that the user has tuned to as the video content on the first display; and
automatically displaying the interactive wagering opportunities on the second display when the television channel that the user has tuned to is related to wagering.

17. The method defined in claim 1, wherein the first display is included in first user equipment and wherein the second display is included in second user equipment, and wherein the first and the second user equipment are indirectly connected through a server, the method comprising:
allowing the user to tune between different television channels;
displaying the television channels that the user has tuned to on the first display as the video content; and
using the server to provide the interactive wagering opportunities on the second display.

18. The method defined in claim 1, wherein the first display is included in first user equipment and wherein the second display is included in second user equipment, and wherein the first and the second user equipment are indirectly connected through a server at a television distribution facility, the method comprising:
allowing the user to tune between different television channels;
displaying the television channels that the user has tuned to on the first display as the video content; and
using the server at the television distribution facility to provide the interactive wagering opportunities on the second display.

19. The method defined in claim 1, wherein the first display is included in first user equipment and wherein the second display is included in second user equipment, and wherein the first and the second user equipment are indirectly connected through a server at a transaction processing and subscription management system, the method comprising:
allowing the user to tune between different television channels;
displaying the television channels that the user has tuned to on the first display as the video content; and
using the server at the transaction processing and subscription management system to provide the interactive wagering opportunities on the second display.

20. The method defined in claim 1 further comprising displaying web content including the interactive wagering opportunities on top of the video as an overlay.

21. The method defined in claim 1, wherein the first display is associated with user equipment and wherein the video is television, the method further comprising:
allowing the user to tune the user equipment to a desired television channel; and
launching a web browser to display web content including the interactive wagering opportunities on the first display when the user tunes to a wagering-related television channel.

22. The method defined in claim 1, wherein the first and the second displays are part of the same user equipment device.

23. The method defined in claim 1, wherein the first display is part of a television and the second display is part of a cellular telephone, the method further comprising allowing the user to use the cellular telephone to place a wager in response to the interactive wagering opportunities.

24. The method defined in claim 1, wherein a set-top box is used to display the video content on the first display, wherein the second display is part of a personal computer, and wherein the personal computer is connected directly to the set-top box to receive information that allows the interactive wagering opportunities that are displayed in the second display to be synchronized with the video content on the first display.

25. The method defined in claim 1, wherein the second display is part of a remote control.

26. The method defined in claim 1, wherein the first display is associated with first user equipment and wherein the second display is associated with second user equipment, the method further comprising using a wireless communications path to send information to the second user equipment.

27. The method defined in claim 1, wherein the first display is associated with first user equipment and wherein the second display is associated with second user equipment, the method further comprising using a wireless communications path to send information to the second user equipment regarding the interactive wagering opportunities.

28. The method defined in claim 1, wherein the first display is a first television connected to a set-top box and wherein the second display is a second television connected to the same set-top box.

29. The method defined in claim 1, wherein the first display is a television having a processor and wherein the second display is a monitor for a personal computer connected to the television.

30. The method defined in claim 1, wherein the first display is a television having a processor and wherein the second display is a monitor for a personal computer that is connected to the television with a FireWire communications link.

31. The method defined in claim 1 further comprising displaying setup options for the user that allow the user to adjust the number of displays that are used to present the video content and the interactive wagering opportunities to the user.

32. The method defined in claim 1 further comprising processing wagers with equipment remote from the first and the second displays when the user responds to an interactive wagering opportunity.

33. The method defined in claim 1, wherein the races involve runners, the method further comprising processing the wager once the wager has been placed.

34. The method defined in claim 1, wherein the races involve runners, and wherein an account is maintained for the user at a transaction processing and subscription management system, the method further comprising processing wagers created by the user in response to the interactive wagering opportunities once the wagers have been placed and crediting the account when the wagers are successful.

35. The method defined in claim 1, wherein the first display is part of user television equipment.

36. The method defined in claim 1, wherein the second display is part of user computer equipment.

37. The method defined in claim 1, wherein the second display is part of user telephone equipment.

38. The method defined in claim 1, wherein the second display is part of a cellular telephone with a display.

39. The method defined in claim 1, wherein the second display is part of a handheld computer.

40. An interactive wagering system in which an interactive wagering application is used to provide a user with an opportunity to place wagers on races that are to be run, comprising:
a first display device configured to display video content; and
a second display device configured to simultaneously display interactive wagering opportunities for the user, wherein the video content and the interactive wagering opportunities are synchronized.

41. The system defined in claim 40 further comprising a direct communications link between equipment for the first display device and equipment for the second display device, wherein the direct communications link is used to synchronize the video content and the interactive wagering opportunities.

42. The system defined in claim 40 further comprising an indirect communications link between equipment for the first display device and equipment for the second display device, wherein the indirect communications link is used to synchronize the video content and the interactive wagering opportunities.

43. The system defined in claim 40, wherein the races involve runners that are horses.

44. The system defined in claim 40, wherein the interactive wagering application provides the user with an opportunity to select a racetrack for the wager.

45. The system defined in claim 40, wherein the interactive wagering application provides the user with an opportunity to select a race for the wager.

46. The system defined in claim 40, wherein the interactive wagering application provides the user with an opportunity to select a wager type for the wager.

47. The system defined in claim 40, wherein the interactive wagering application provides the user with an opportunity to select a wager amount for the wager.

48. The system defined in claim 40, wherein the interactive wagering application provides the user with an opportunity to select a runner or runners for the wager.

49. The system defined in claim 40, wherein the races involve runners, wherein the first display device is configured to display content on a particular race, and wherein the second display device is configured to simultaneously display content that provides the user with an opportunity to create a wager for that particular race.

50. The system defined in claim 40, wherein the interactive wagering application provides the user with an option on the first display device and wherein the interactive wagering application is configured to display the interactive wagering opportunities on the second display device in response to the user selecting the option on the first display device.

51. The system defined in claim 40, wherein the interactive wagering application provides the user with an option on the second display device and wherein the interactive wagering application is configured to display the interactive wagering opportunities on the second display device in response to the user selecting the option on the second display device.

52. The system defined in claim 40, wherein the interactive wagering application provides the user with an option on the second display device and wherein the interactive wagering application is configured to display the interactive wagering opportunities on the first display device as an overlay on top of the video on the first display device in response to the user selecting the option on the second display device.

53. The system defined in claim 40, wherein the interactive wagering application provides the user with an option on the second display device and wherein the interactive wagering application is configured to display the interactive wagering opportunities on the first display device as a wrap-around region on the first display device in response to the user selecting the option on the second display device.

54. The system defined in claim 40, wherein the video content is a wagering television channel and wherein the second display device is a personal computer monitor, the system further comprising:
a computer coupled to the personal computer monitor and configured to display the interactive wagering opportunities on the monitor; and
a set-top box configured to allow a user to tune to the wagering television channel.

55. The system defined in claim 40, wherein:
the video content is television;
the first display device is a television that is configured to allow a user to tune between different television channels; and
the second display device is included in user equipment that is configured to automatically display the interactive wagering opportunities when the television channel that the user has tuned to is related to wagering.

56. The system defined in claim 40, wherein:
the interactive wagering application is configured to allow a user to tune between different television channels;
the first display device is included in first user equipment that is configured to display the television channels that the user has tuned to as the video content; and
the second display device is included in second user equipment, the system further comprising a server configured to provide the interactive wagering opportunities on the second display device, wherein the first and second equipment are indirectly connected through the server.

57. The system defined in claim 40, wherein:
the interactive wagering application is configured to allow a user to tune between different television channels;
the first display device is included in first user equipment that is configured to display the television channel that the user has tuned to as the video content; and
the second display device is included in second user equipment, the system further comprising a server at a television distribution facility configured to provide the interactive wagering opportunities on the second display device, wherein the first and second equipment are indirectly connected through the server at the television distribution facility.

58. The system defined in claim 40, wherein:
the interactive wagering application is configured to allow a user to tune between different television channels;
the first display device is included in first user equipment that is configured to display the television channel that the user has tuned to as the video content; and
the second display device is included in second user equipment, the system further comprising a server at a transaction processing and subscription management system configured to provide the interactive wagering opportunities on the second display device, wherein the first and second equipment are indirectly connected through the server at the transaction processing and subscription management system.

59. The system defined in claim 40 wherein the first display device is configured to display web content including the interactive wagering opportunities on top of the video content as an overlay.

60. The system defined in claim 40, wherein the video content is television and wherein the first display device is associated with user equipment that is configured to allow a user to tune to a desired television channel, the system further comprising a web browser configured to automatically launch and display web content including the interactive wagering opportunities on the first display device when the user tunes to a wagering-related television channel.

61. The system defined in claim 40, wherein the first and the second display devices are part of the same user equipment.

62. The system defined in claim 40, wherein the first display device is a television and wherein the second display device is part of a cellular telephone that is configured to allow the user to place a wager in response to the interactive wagering opportunities.

63. The system defined in claim 40, further comprising:
a set-top box configured to display the video content on the first display device; and
a personal computer that includes the second display device, wherein the personal computer is connected directly to the set-top box and is configured to receive information that allows the interactive wagering opportunities that are displayed on the second display device to be synchronized with the video content on the first display device.

64. The system defined in claim 40, further comprising a remote control that includes the second display device.

65. The system defined in claim 40, wherein:
the first display device is associated with first user equipment;
the second display device is associated with second user equipment; and
the second user equipment includes a wireless receiver configured to receive information.

66. The system defined in claim 40, wherein:
the first display device is associated with first user equipment;
the second display device is associated with second user equipment; and
the second user equipment includes a wireless receiver configured to receive information regarding the interactive wagering opportunities.

67. The system defined in claim 40, wherein the first display device is a first television and wherein the second display device is a second television, the system further comprising a set-top box that is coupled to the first television and the second television.

68. The system defined in claim 40, wherein the first display device is a television having a processor and wherein the second display device is a personal computer monitor coupled to the television.

69. The system defined in claim 40, wherein the first display device is a television having a processor and wherein the second display device is a personal computer monitor, the system further comprising:
a personal computer coupled to the personal computer monitor; and
a FireWire communications link that couples the personal computer to the television.

70. The system defined in claim 40 further comprising a display device configured to display setup options that allow the user to adjust the number of displays that are used to present the video content and the interactive wagering opportunities to the user.

71. The system defined in claim 40 further comprising equipment remote from the first and the second display devices that is configured to process wagers when the user responds to the interactive wagering opportunities.

72. The system defined in claim 40, wherein the races involve runners, the system further comprising processing equipment configured to process the wager once the wager has been placed.

73. The system defined in claim 40, wherein the races involve runners, the system further comprising:
a transaction processing and subscription management system configured to maintain an account for the user; and
processing equipment configured to process wagers created by the user in response to the interactive wagering opportunities once the wagers have been placed and credit the account when the wagers are successful.

74. The system defined in claim 40, further comprising user television equipment that includes the first display device.

75. The system defined in claim 40, further comprising user computer equipment that includes the second display device.

76. The system defined in claim 40, further comprising user telephone equipment that includes the second display device.

77. The system defined in claim 40, further comprising a cellular telephone that includes the second display device.

78. The system defined in claim 40, further comprising a handheld computer that includes the second display device.
